(19) United States
(12) Patent Application Publication
(10) Pub. No.: US 2026/0116292 A1
(43) Pub. Date: Apr. 30, 2026

(54) MITIGATION SYSTEM AND METHOD FOR A VEHICLE

(71) Applicant: Harley-Davidson Motor Company, Inc., Milwaukee, WI (US)

(72) Inventors: Russell Barnett, Milwaukee, WI (US); Matthew Rasmussen, Milwaukee, WI (US)

(73) Assignee: Harley-Davidson Motor Company, Inc., Milwaukee, WI (US)

(21) Appl. No.: 19/368,268

(22) Filed: Oct. 24, 2025

Related U.S. Application Data
(60) Provisional application No. 63/712,876, filed on Oct. 28, 2024.

(51) Int. Cl. B60Q 9/00; G06V 10/80; G06V 10/82; G06V 20/58; G07C 5/02

(52) U.S. Cl. CPC B60Q 9/008; G07C 5/02; G06V 10/803; G06V 10/82; G06V 20/58

(57) ABSTRACT

A system is disclosed for use with a vehicle. The system includes: a memory having instructions stored therein; and a processor configured to execute the instructions to cause the system to: determine whether wildlife is near the vehicle; determine a risk level R_{L} of the wildlife; determine whether R_{L} is less than a predetermined threshold risk level R_{threshold}; and activate a warning to a driver of the vehicle when R_{L} is not less than R_{threshold}.

The present application claims priority from U.S. Provisional Application No. 63/712,876 filed Oct. 28, 2024, the entire disclosure of which is incorporated herein by reference.

### TECHNICAL FIELD

One or more embodiments relate generally to reducing vehicular incidents with objects.

### BACKGROUND

It may be difficult for a rider of a motorcycle to detect objects, including wildlife. Incidents with objects may interrupt a rider's enjoyment and detract from the riding experience. In some instances, wildlife will exit bushes or fields at the side of the road and may go unnoticed by a motorcycle rider. Then, seemingly without warning, the wildlife may end up in the path of the motorcycle.

### SUMMARY

An aspect of the present disclosure is drawn to a system for use with a vehicle. The system may increase awareness of nearby wildlife, such as to an operator of the vehicle. This may increase the ability to avoid the wildlife, such as in the event the wildlife crosses into the vehicle's path. The system includes: a memory having instructions stored therein; and a processor configured to execute the instructions to cause the system to: determine whether wildlife is near the vehicle; determine a risk level R_{L} of the wildlife; determine whether R_{L} is less than a predetermined threshold risk level R_{threshold}; and activate a warning to a driver of the vehicle when R_{L} is not less than R_{threshold}.

In one or more embodiments of this aspect, the processor is configured to execute the instructions to cause the system to determine whether wildlife is near the vehicle by: receiving data from at least one of a group of data types including image data, thermal data, light detection and ranging (LIDAR) data, radar data, and combinations thereof; and analyzing the received data. In one or more of these embodiments, the processor is configured to execute the instructions to cause the system to determine whether wildlife is near the vehicle by analyzing the received data by comparing the received data with one of historical data associated with wildlife, synthetic data associated with wildlife, a priori data associated with wildlife, and combinations thereof. In one or more of these embodiments, the processor is configured to execute the instructions to cause the system to determine whether wildlife is near the vehicle by analyzing the received data with a pre-trained artificial intelligence (“AI”) system that has been pre-trained to identify wildlife based on training data from the at least one of the group of data types including training image data, training thermal data, training LIDAR data, training radar data, and combinations thereof, and wherein the received data corresponds to a field of view of at least one of the image data, the thermal data, the LIDAR data, the radar data, and combinations thereof.

In one or more embodiments of this aspect, the processor is configured to execute the instructions to cause the system to determine the R_{L} of the wildlife based on a parameter selected from a group of parameters including animal type, animal size, animal distance to the vehicle, animal velocity, bearing of the vehicle, vehicle velocity, and combinations thereof.

In one or more embodiments of this aspect, the processor is configured to execute the instructions to cause the system to activate the warning as selected from a group of warnings including an audible signal, a visual indicator, a haptic signal, a wireless signal, and combinations thereof. In one or more of these embodiments, the processor is additionally configured to execute the instructions to cause the system to: determine whether R_{L} is less than a predetermined second threshold risk level R_{threshold2}; activate a second warning to the driver of the vehicle when R_{L} is not less than R_{threshold2}; and activate the second warning as selected from the group of warnings, wherein the warning is different from the second warning.

Another aspect of the present disclosure is drawn to a system including: a vehicle; and a system including a memory and a processor, wherein the memory includes instructions stored therein, and wherein the processor is configured to execute the instructions to cause the system to: determine whether wildlife is near the vehicle; determine a risk level R_{L} of the wildlife; determine whether R_{L} is less than a predetermined threshold risk level R_{threshold}; and activate a warning to a driver of the vehicle when R_{L} is not less than R_{threshold}.

In one or more embodiments of this aspect, the processor is configured to execute the instructions to cause the system to determine whether wildlife is near the vehicle by: receiving data from at least one of a group of data types including image data, thermal data, LIDAR data, radar data, and combinations thereof; and analyzing the received data. In one or more of these embodiments, the processor is configured to execute the instructions to cause the system to determine whether wildlife is near the vehicle by analyzing the received data by comparing the received data with one of historical data associated with wildlife, synthetic data associated with wildlife, a priori data associated with wildlife, and combinations thereof. In one or more of these embodiments, the processor is configured to execute the instructions to cause the system to determine whether wildlife is near the vehicle by analyzing the received data with a pre-trained AI system that has been pre-trained to identify wildlife based on training data from at least one of the group of data types including training image data, training thermal data, training LIDAR data, training radar data, and combinations thereof, and wherein the received data corresponds to a field of view of at least one of the image data, the thermal data, the LIDAR data, the radar data, and combinations thereof.

In one or more embodiments of this aspect, the processor is configured to execute the instructions to cause the system to determine the R_{L} of the wildlife based on parameter selected from a group of parameters including animal type, animal size, animal distance to the vehicle, animal velocity, bearing of the vehicle, vehicle velocity, and combinations thereof.

In one or more embodiments of this aspect, the processor is configured to execute the instructions to cause the system to activate the warning as selected from a group of warnings including an audible signal, a visual indicator, a haptic signal, a wireless signal, and combinations thereof. In one or more of these embodiments, the processor is additionally configured to execute the instructions to cause the system to: determine whether R_{L} is less than a predetermined second threshold risk level R_{threshold2}; activate a second warning to the driver of the vehicle when R_{L} is not less than R_{threshold2}; and activate the second warning as selected from the group of warnings, wherein the warning is different from the second warning.

Another aspect of the present disclosure is drawn to method of using a system, wherein the method includes: determining, via a processor in a system including a memory and the processor, the memory including instructions stored therein, the processor being configured to execute the instructions, whether wildlife is near a vehicle having the system; determining, via the processor, a risk level R_{L} of the wildlife; determining, via the processor, whether R_{L} is less than a predetermined threshold risk level R_{threshold}; and activating, via the processor, a warning to a driver of the vehicle when R_{L} is not less than R_{threshold}.

In one or more embodiments of this aspect, the determining whether wildlife is near the vehicle having the system includes: receiving, via the processor, data of at least one of a group of data types including image data, thermal data, LIDAR data, radar data, and combinations thereof; and analyzing the received data. In one or more of these embodiments, the analyzing the received data includes analyzing, via the processor, the received data by comparing the received data with one of historical data associated with wildlife, synthetic data associated with wildlife, a priori data associated with wildlife, and combinations thereof. In one or more of these embodiments, the analyzing the received data includes analyzing, via the processor, the received data by analyzing the received data with a pre-trained AI system that has been pre-trained to identify wildlife based on training data from the at least one of the group of data types including training image data, training thermal data, training LIDAR data, training radar data, and combinations thereof,

In one or more embodiments of this aspect, the determining the R_{L} of the wildlife is based on a parameter selected from a group of parameters including animal type, animal size, animal distance to the vehicle, animal velocity, bearing of the vehicle, vehicle velocity, and combinations thereof.

In one or more embodiments of this aspect, the activating the warning includes activating the warning as selected from a group of warnings including an audible signal, a visual indicator, a haptic signal, a wireless signal, and combinations thereof.

### BRIEF SUMMARY OF THE DRAWINGS

The accompanying drawings, which are incorporated in and form a part of the specification, illustrate and explain example embodiments. In the drawings:

FIG. 1A illustrates a first person view of a person riding a motorcycle at a time t₀;

FIG. 1B illustrates a first person view of the person riding the motorcycle of FIG. 1A at a time t₁;

FIG. 2 illustrates rider's view of a motorcycle;

FIG. 3 illustrates an example visual indicator as a warning on a TFT screen of a motorcycle in accordance with one or more embodiments;

FIG. 4 illustrates a block diagram of example systems of a vehicle in accordance with one or more embodiments;

FIG. 5 illustrates a block diagram of an example mitigation system of the vehicle of FIG. 4;

FIG. 6 illustrates an example method of warning a vehicle user of wildlife in accordance with one or more embodiments;

FIG. 7A illustrates a top-down view of a vehicle detecting wildlife in accordance with one or more embodiments;

FIG. 7B illustrates a top-down view of a vehicle detecting a dog and a person in accordance with one or more embodiments;

FIG. 7C illustrates a top-down view of a vehicle detecting a pedestrian in accordance with one or more embodiments;

FIG. 7D illustrates a top-down view of a vehicle detecting an object in accordance with one or more embodiments;

FIG. 7E illustrates a top-down view of a vehicle illuminating the ground in a direction of the wildlife of FIG. 7A in accordance with one or more embodiments;

FIG. 8 illustrates a block diagram of an example process for generating a risk level of a detected object in accordance with one or more embodiments;

FIG. 9 illustrates a block diagram of the artificial intelligence (“AI”) system of FIG. 8 in accordance with one or more embodiments;

FIG. 10 illustrates a block diagram of the other vehicle layer of the AI system of FIG. 9 in accordance with one or more embodiments;

FIG. 11 illustrates a block diagram of the pedestrian layer of the AI system of FIG. 9 in accordance with one or more embodiments;

FIG. 12 illustrates a block diagram of the object layer of the AI system of FIG. 9 in accordance with one or more embodiments;

FIG. 13 illustrates a block diagram of the wildlife layer of the AI system of FIG. 9 in accordance with one or more embodiments; and

FIG. 14 illustrates a table associating increasing risk level thresholds with corresponding warning actions in accordance with one or more embodiments.

### DETAILED DESCRIPTION

A system and method in accordance with one or more embodiments increases a motorcycle rider's awareness of nearby objects in order to increase the motorcycle rider's ability to avoid the object in the event it subsequently ends up in the path of the motorcycle. A nearby object is an object that is near, observably close, or within a proximity to the motorcycle, such as at the roadside, ahead of, behind, or beside the motorcycle.

In one or more embodiments, a mitigation system may be used with a vehicle, such as a motorcycle. The mitigation system may use scanned environment data to detect nearby objects in real-time. The mitigation system may then determine a risk level R_{L} of a detected object, wherein the risk level corresponds to a probability score as to whether the object poses a risk to the user of the vehicle. The mitigation system may then determine whether the risk level R_{L} is less than a predetermined risk level threshold R_{threshold}. If it is determined that the risk level R_{L} is not less than the predetermined risk level threshold R_{threshold}, then the mitigation system may activate a warning to the user of the vehicle.

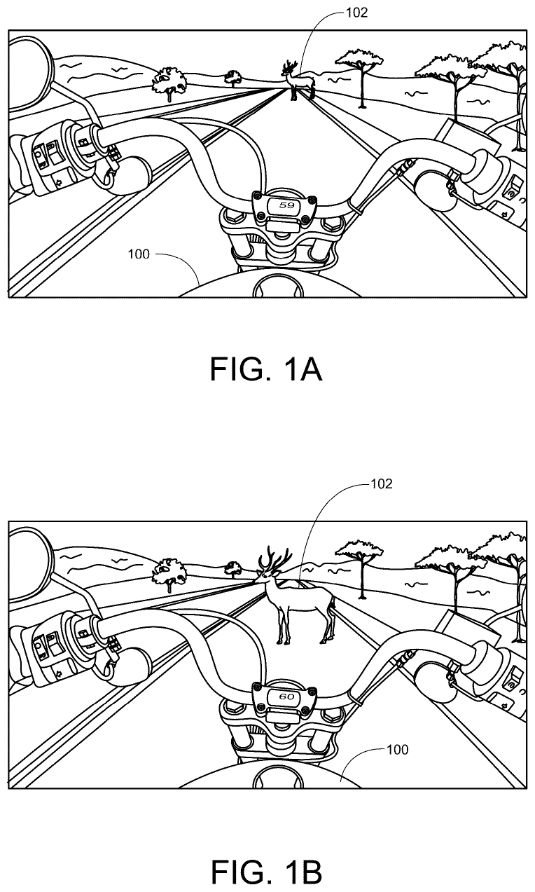

Example systems and methods for warning a vehicle user of an object in accordance with one or more embodiments will now be described in greater detail with reference to FIGS. 1A-8.

FIG. 1A illustrates a first person view of a person riding a motorcycle 100, such as at night, at a time t₀. At this time, a deer 102 is in front and to the right of motorcycle 100.

FIG. 1B illustrates a first person view of the person riding the motorcycle 100 at a time t₁. At time t₁, deer 102 has passed in front of motorcycle 100 so as to be in front of and to the left of motorcycle 100. Further, at time t₁, deer 102 is much closer to motorcycle 100.

It is desired, in situations as discussed above with reference to FIGS. 1A-B, to maximize the time of location and identification of deer 102 in an area around motorcycle 100, in order to maximize a response time for the operator of motorcycle 100. In this manner, the operator of motorcycle 100 may take action to steer around or otherwise avoid the deer 102.

In accordance with one or more embodiments, a mitigation system may provide an early warning to the operator of motorcycle 100 by quickly and automatically locating and identifying deer 102 and displaying an icon of a deer to the operator of motorcycle 100.

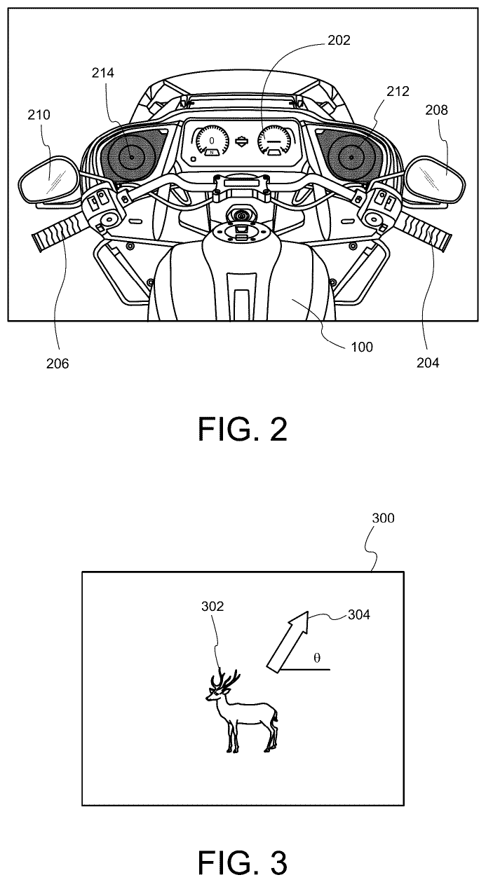

FIG. 2 illustrates a rider's view of motorcycle 100. As shown in the figure, motorcycle 100 includes a thin-film-transistor (TFT) screen 202, a right handle bar grip 204, a left handle bar grip 206, a right rear view mirror 208, a left rear view mirror 210, a front right speaker 212, and a left front speaker 214.

FIG. 3 illustrates an example visual indicator 300 as a warning on TFT screen 202 of motorcycle 100 (not shown) in accordance with one or more embodiments. As shown in FIG. 3, visual indicator 300 includes a wildlife icon 302 and an arrow 304. In this example, wildlife icon 302 resembles a deer, thus indicating to the operator of motorcycle 100 that a deer is in the environment around motorcycle 100. Further, arrow 304 has a size and angle θ, wherein the size may indicate a distance of deer 102 from motorcycle 100 and the angle θ provides a direction of 102 deer from the front of motorcycle 100. In this manner, the operator of motorcycle 100 may pay more attention to the location in front of motorcycle 100 as directed by arrow 304 so as to locate deer 102. Therefore, the operator of the motorcycle 100 may have an early warning of deer 102.

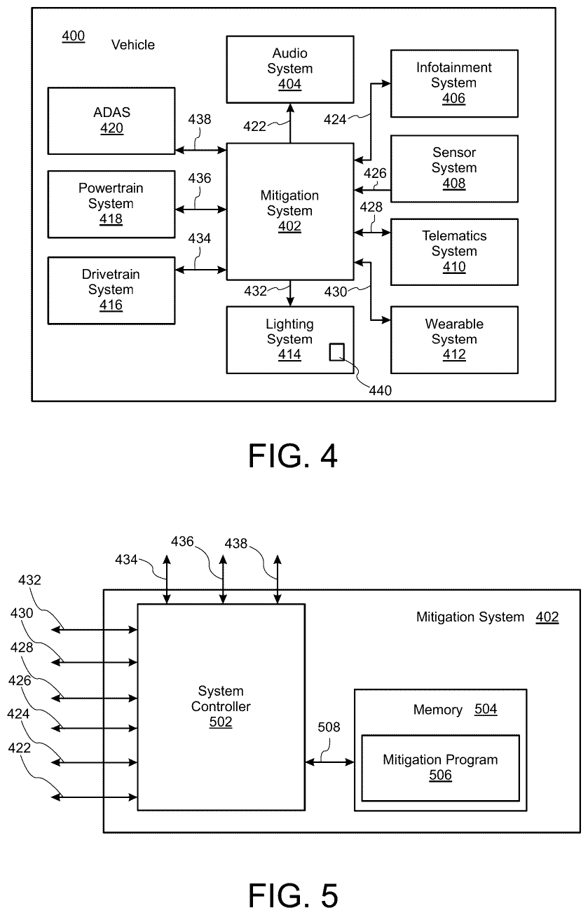

The example motorcycle system discussed above with reference to FIGS. 1A-3 is provided for general discussion of a single example. A more detailed discussion of embodiments in accordance with the present disclosure will now be provided with reference to FIGS. 4-8.

FIG. 4 illustrates a block diagram of example systems of a vehicle 400 in accordance with one or more embodiments.

As shown in the figure, vehicle 400 includes a mitigation system 402. The vehicle 400 may further include an audio system 404, an infotainment system 406, a sensor system 408, a telematics system 410, a wearable system 412, a lighting system 414, a drivetrain system 416, a powertrain system 418, an advanced driver assistance system (ADAS) 420, and/or communication channels 422, 424, 426, 428, 430, 432, 434, 436, and 438. Mitigation system 402, for example, may be connected to or in communication with one or more of the following: the audio system 404, the infotainment system 406, the sensor system 408, the telematics system 410, the wearable system 412, the lighting system 414, the drivetrain system 416, the powertrain system 418, the ADAS 420.

In this example, mitigation system 402, audio system 404, infotainment system 406, sensor system 408, telematics system 410, wearable system 412, lighting system 414, drivetrain system 416, powertrain system 418, and ADAS 420 are illustrated as individual elements of vehicle 400. However, in one or more embodiments, at least two of mitigation system 402, audio system 404, infotainment system 406, sensor system 408, telematics system 410, wearable system 412, lighting system 414, drivetrain system 416, powertrain system 418, and ADAS 420 may be combined as a unitary device. Further, in one or more embodiments, at least one of mitigation system 402, audio system 404, infotainment system 406, sensor system 408, telematics system 410, wearable system 412, lighting system 414, drivetrain system 416, powertrain system 418, and ADAS 420 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to vehicle 400 such that the processor may read information from and write information to the tangible computer-readable media. In the alternative, the tangible computer-readable media may be integral to vehicle 400. The tangible computer-readable media may reside in an integrated circuit (IC), an ASIC, or large-scale integrated circuit (LSI), system LSI, super LSI, or ultra LSI components that perform a part or all of the functions described herein. In the alternative, the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

In the figure, mitigation system 402 is configured to: communicate with audio system 404 via communication channel 422; communicate with infotainment system 406 via communication channel 424; communicate with sensor system 408 via communication channel 426; communicate with telematics system via communication channel428; communicate with wearable system 412 via communication channel 430; communicate with lighting system 414 via communication channel 432; communicate with drivetrain system 416 via communication channel 434; communicate with powertrain system 418 via communication channel 436; and communicate with ADAS 420 via communication channel 438.

Mitigation system 402 may be any device or system that is configured to detect wildlife and provide a warning to the user in accordance with one or more embodiments as will be described in greater detail below.

Audio system 404 may be any device or system that is configured to deliver sound to the user of vehicle 400. In one or more embodiments, audio system 404 may include at least one of: a stereo that has an AM/FM radio, a CD player, USB ports for auxiliary connectivity, Bluetooth connectivity for streaming music from mobile devices; speakers for converting electrical signals into audible sound; an amplifier for boosting the audio signal's power to drive the speakers; and combinations thereof.

Infotainment system 406 may be any device or system that is configured to integrate information and entertainment functionalities into a single platform. In one or more embodiments, infotainment system 406 may include at least one of an integrated head-unit, connectivity modules, a digital instrument cluster, and combinations thereof. The integrated head-unit is the primary control center, usually featuring a touchscreen interface that allows users to navigate different functionalities easily. The connectivity modules enable GPS, Bluetooth, and Wi-Fi capabilities to facilitate smartphone integration and internet access. The digital instrument cluster replaces traditional analog gauges with digital displays that provide real-time data about speed, fuel levels, and navigation, etc. Non-limiting examples features and services of infotainment system 406 include: voice recognition enabling hands-free operation for safety while driving; navigation for real-time traffic updates and turn-by-turn directions; audio/video playback to support various media formats and streaming services; smartphone integration to mirror functionalities of the user's smartphone on the screen of infotainment system 406; and vehicle diagnostics for displaying information related to vehicle performance and alerts for maintenance needs.

Sensor system 408 may be any device or system that is configured to collect and process data about the surroundings of vehicle 400. In one or more embodiments, sensor system 408 may include at least one of: one or more infra-red (IR) still cameras; one or more visible spectrum still cameras; one or more ultra-violet (UV) still cameras; one or more hyperspectral still cameras configured to generate a still image include at least two of the IR spectrum, the visible spectrum, and the UV spectrum; one or more IR video cameras; one or more visible spectrum video cameras; one or more UV video cameras; one or more hyperspectral video cameras configured to generate a video image include at least two of the IR spectrum, the visible spectrum, and the UV spectrum; one or more microphones; one or more radars; one or more LIDAR sensors; one or more temperature sensors; one or more rain sensors; one or more light sensors; one or more pressure sensors; and combinations thereof.

Telematics system 410 may be any device or system that is configured to combine telecommunications and informatics to collect, transmit, and analyze data about the operation and performance of vehicle 400. In one or more embodiments, telematics system 410 may include at least one of a global positioning system (GPS) receiver, accelerometer, cellular or satellite communication module, an interface to connect with an onboard diagnostics (OBD-II) port of vehicle 400, a subscriber identity module (SIM) card for data transmission, and combinations thereof.

Wearable system 412 may be any device or system that is configured to monitor the health of the driver of vehicle 400. In one or more embodiments, wearable system 412 may continuously monitor vital signs such as heart rate, stress levels, and oxygen saturation. This data can be used to adjust driving modes or provide alerts when the driver shows signs of fatigue or stress. Wearable system 412, for example, may be in a helmet, jacket, or other riding gear. The wearable system, for example, may be a headset or speaker system in a helmet. The wearable system may be connected to or communicate with the vehicle 400. The wearable system, may for example, provide alerts to the driver of the vehicle 400 when wildlife is detected by mitigation system 402.

Lighting system 414 may be any device or system that is configured to provide visibility for the driver of vehicle 400 and signaling to other road users. In one or more embodiments, lighting system 414 may provide at least one of forward illumination, conspicuity and signal illumination, interior lighting (in the event the vehicle is an automobile), and combinations thereof.

As for forward illumination, lighting system 414 may include headlights and auxiliary lights. Headlights are the primary source of forward illumination and may include high beams and low beams. High beams provide intense light for dark conditions without glare control, which is suitable for isolated roads. Low beams are designed to illuminate the road without blinding oncoming drivers, which is ideal for urban driving. Auxiliary lights are additional lights that enhance visibility and may include fog lights and cornering lights. Fog lights are positioned low to produce a wide beam that reduces glare in foggy conditions. Cornering lights activate during turns to illuminate the direction of travel.

As for conspicuity and signal lights, these include taillights, turn signals and daytime running lights (DRLs). Taillights are located at the rear, and signal braking and turning. They typically emit red light and may vary in brightness depending on their function (e.g., stop vs. position lights). Turn signals are flashing lights that indicate a vehicle's intention to turn or change lanes. DRLs enhance a vehicle's visibility during daylight hours.

As for interior lighting, this may include dome lights, ambient lighting and instrument lighting. Dome lighting provides illumination inside the vehicle, often activated by door openings. Ambient lighting enhances the cabin atmosphere and assists in locating controls at night. Instrument lighting, which is also included in motorcycles, illuminates the dashboard and controls to ensure visibility while driving.

As will be described in greater detail below, in one or more embodiments, lighting system 414 may additionally include a steerable illuminator 440 to illuminate detected objects. Steerable illuminator 440 may be any known type of steerable illuminator, a non-limiting example of which includes an adaptive driving beam.

Drivetrain system 416 may be any device or system that is configured to manage power flow from the engine to the wheels. In one or more embodiments, drivetrain system 416 may include at least one of an engine control unit (ECU), a transmission control unit (TCM), a differential control system, a traction control system (TCM), and combinations thereof. The ECU serves as the brain of drivetrain system 416, by continuously monitoring various sensors and adjusting engine parameters to optimize performance and fuel efficiency. The TCM manages gear shifts and clutch engagement. It communicates with the ECU to ensure smooth power delivery and optimal gear selection based on driving conditions. The differential control system adjusts power distribution between wheels to enhance traction and handling, especially in all-wheel-drive (AWD) and four-wheel-drive (4WD) vehicles.

Powertrain system 418 may be any device or system that is configured to manage the power produced by the engine. In one or more embodiments, powertrain system 418 may integrate the functions of the ECU and the TCU of drivetrain system 416 by managing fuel injection, ignition timing, air-to-fuel ratios, and idle speed control.

ADAS 420 may be any device or system that is configured to enhance safety and rider experience. In one or more embodiments, ADAS 420 may include at least one of a collision avoidance system, a lane management system, an adaptive cruise control system, and combinations thereof. A collision avoidance system may include at least one of a forward collision warning (FCW) system, a rear-end collision warning system (RCW), and combinations thereof. An FCW system alerts the vehicle driver of potential frontal collisions, giving the driver time to react and act. An RCW system monitors rearward traffic and warns the vehicle driver of vehicles approaching at high speeds. A lane management system may include at least one of a blind spot detection (BSD) system, a lane change assist (LCA) system, a lane departure alert system, and combinations thereof. A BSD system may use radar sensors to monitor blind spots and alert the vehicle driver of vehicles in those areas. An LCA system may warn the vehicle driver of potentially dangerous lane changes, especially in high-speed scenarios. A lane departure alert system may warn the vehicle driver when they are close to crossing lane markings unintentionally. An adaptive cruise control system automatically maintains a safe distance from a vehicle ahead while cruising. ADAS 420, for example, may include an automated driving system. The automated driving system may perform an automated driving function, such as in response to detection of wildlife via mitigation system 402. The automated driving function may cause the vehicle 400 to accelerate, may cause the vehicle to slow or stop, or may cause a course change.

Each of communication channels 422, 424, 426, 428, 430, 432, 434, 436, and 438 may be any known type of wired communication channel or wireless communication channel, that is configured to transmit data.

A more detailed discussion of mitigation system 402 will now be provided with reference to FIG. 5.

FIG. 5 illustrates a block diagram of mitigation system 402. As shown in the figure, mitigation system 402 includes a system controller 502, a memory 504 having a mitigation program 506 stored therein, and a communication channel 508.

In this example, system controller 502 and memory 504 are illustrated as individual elements of mitigation system 402. However, in one or more embodiments, system controller 502 and memory 504 may be combined as a unitary device. Further, in one or more embodiments, system controller may be implemented as a computer having non-transitory computer-readable media for carrying or having computer-executable instructions or data structures stored thereon.

System controller 502 is configured to: communicate with memory 504 via communication channel 508; communicate with audio system 404 via communication channel 422; communicate with infotainment system 406 via communication channel 424; communicate with sensor system 408 via communication channel 426; communicate with telematics system 410 via communication channel 428; communicate with wearable system 412 via communication channel 430; communicate with lighting system 414 via communication channel 432; communicate with drivetrain system 416 via communication channel 434; communicate with powertrain system 418 via communication channel 436; and communicate with ADAS 420 via communication channel 438.

System controller 502 may be any device or system that is configured to control general operations of mitigation system 402 and includes, but is not limited to, a central processing unit (CPU), a hardware microprocessor, a single core processor, a multi-core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of mitigation system 402.

Memory 504 may be any device or system capable of storing data and instructions used by mitigation system 402 and includes, but is not limited to, random-access memory (RAM), dynamic random-access memory (DRAM), a hard drive, a solid-state drive, read-only memory (ROM), erasable programmable read-only memory (EPROM), electrically erasable programmable read-only memory (EEPROM), flash memory, embedded memory blocks in an FPGA, or any other various layers of memory hierarchy.

Mitigation program 506 controls the operations of mitigation system 402. Mitigation program 506, having a set (at least one) of program modules, may be stored in memory 504 by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the present disclosure.

As will be described in greater detail below, in one or more embodiments, mitigation program 506 includes a threshold risk level R_{threshold} stored therein and instructions, that when executed by system controller 502, cause mitigation system 402 to: determine whether an object is near vehicle 400; determine a risk level R_{L} of the object; determine whether R_{L} is less than R_{threshold}; and activate a warning to a driver of vehicle 400 when R_{L} is not less than R_{threshold}.

As will be described in greater detail below, in one or more embodiments, mitigation program 506 may additionally include instructions, that when executed by system controller 502, cause mitigation system 402 additionally to analyze data received by sensor system 408.

As will be described in greater detail below, in one or more embodiments, mitigation program 506 may additionally include instructions, that when executed by system controller 502, cause mitigation system 402 additionally to analyze data received by sensor system 408 via a pre-trained machine learning algorithm that has been pre-trained to identify objects based on training data from at least one of: historical data associated with objects; synthetic data associated with objects; a priori data associated with objects; and combinations thereof.

As will be described in greater detail below, in one or more embodiments, mitigation program 506 may additionally include instructions, that when executed by system controller 502, cause mitigation system 402 additionally to analyze data received by sensor system 408 via a pre-trained machine learning algorithm that has been pre-trained to identify objects based on at least one data type of the group of data types including: IR still image data from one or more IR still cameras; visible spectrum still image data from one or more visible spectrum still cameras; UV still image data from one or more UV still cameras; hyperspectral still image data from one or more hyperspectral still cameras; IR video data from one or more IR video cameras; visible spectrum video data from one or more visible spectrum cameras; UV video data from one or more UV video cameras; hyperspectral video data from one or more hyperspectral video cameras; audio data from one or more microphones; radar data from one or more radars; LIDAR data from one or more LIDAR sensors; temperature data from one or more temperature sensors; rain data from one or more rain sensors; light data from one or more light sensors; pressure data from one or more pressure sensors; and combinations thereof.

As will be described in greater detail below, in one or more embodiments, mitigation program 506 additionally includes instructions, that when executed by system controller 502, cause mitigation system 402 additionally to determine the R_{L} of the object based on a parameter selected from a group of parameters comprising object type, object distance to the vehicle, object velocity, bearing of the vehicle, vehicle velocity, and combinations thereof.

As will be described in greater detail below, in one or more embodiments, mitigation program 506 additionally includes instructions, that when executed by system controller 502, cause mitigation system 402 additionally to determine the R_{L} of the object based on a parameter selected from a group of parameters comprising animal type, animal size, and combinations thereof, when the object is determined to be an animal.

As will be described in greater detail below, in one or more embodiments, mitigation program 506 additionally includes instructions, that when executed by system controller 502, cause mitigation system 402 additionally to activate the warning as selected from a group of warnings including an audible signal, a visual indicator, a haptic signal, a wireless signal, and combinations thereof.

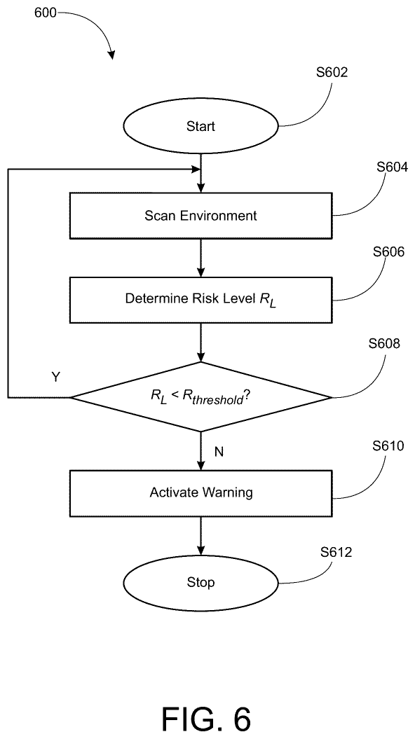

A method of operation of mitigation system 402 will now be described with additional reference to FIG. 6.

FIG. 6 illustrates an example method 600 of warning a vehicle user of an object in accordance with one or more embodiments.

As shown in the figure, method 600 starts (S602) and the environment is scanned (S604). For example, as shown in FIG. 4, sensor system 408 may scan the environment around vehicle 400 and provide scanned data to mitigation system 402.

In one or more embodiments, the environment scanning may include scanning a predetermined field of view that is less than 360° around the vehicle using: one or more IR still cameras; one or more visible spectrum still cameras; one or more UV still cameras; one or more hyperspectral still cameras configured to generate a still image include at least two of the IR spectrum, the visible spectrum, and the UV spectrum; one or more IR video cameras; one or more visible spectrum video cameras; one or more UV video cameras; one or more hyperspectral video cameras configured to generate a video image include at least two of the IR spectrum, the visible spectrum, and the UV spectrum; one or more microphones; one or more radars; one or more LIDAR sensors; one or more temperature sensors; one or more rain sensors; one or more light sensors; one or more pressure sensors; and combinations thereof.

In one or more embodiments, the environment scanning may include scanning 360° around the vehicle using: one or more IR still cameras; one or more visible spectrum still cameras; one or more UV still cameras; one or more hyperspectral still cameras configured to generate a still image include at least two of the IR spectrum, the visible spectrum, and the UV spectrum; one or more IR video cameras; one or more visible spectrum video cameras; one or more UV video cameras; one or more hyperspectral video cameras configured to generate a video image include at least two of the IR spectrum, the visible spectrum, and the UV spectrum; one or more microphones; one or more radars; one or more LIDAR sensors; one or more temperature sensors; one or more rain sensors; one or more light sensors; one or more pressure sensors; and combinations thereof.

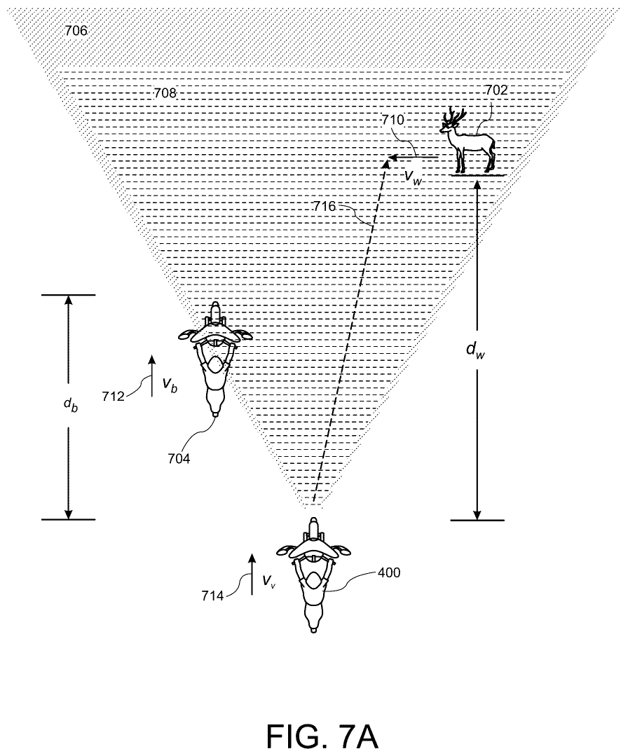

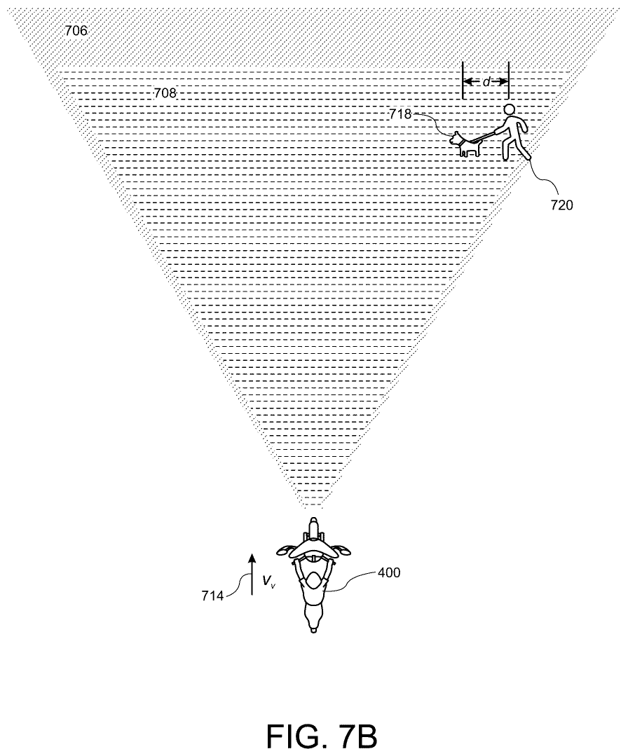

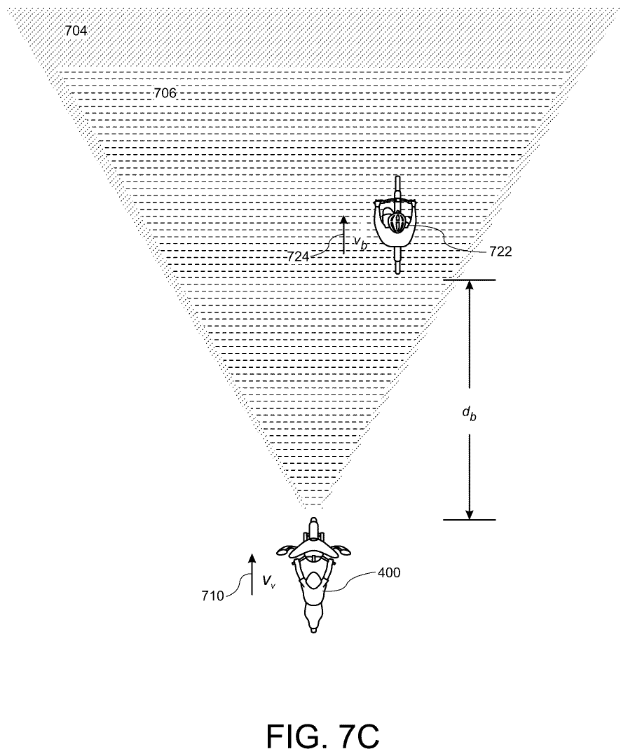

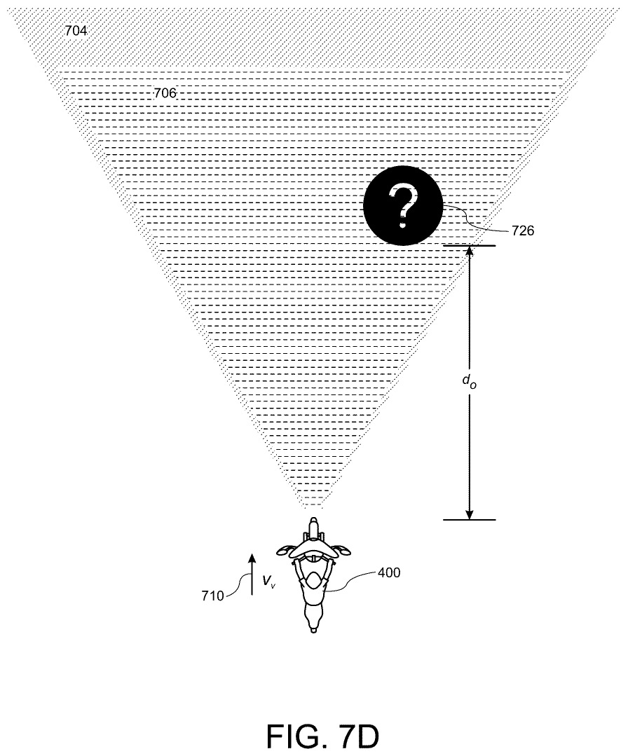

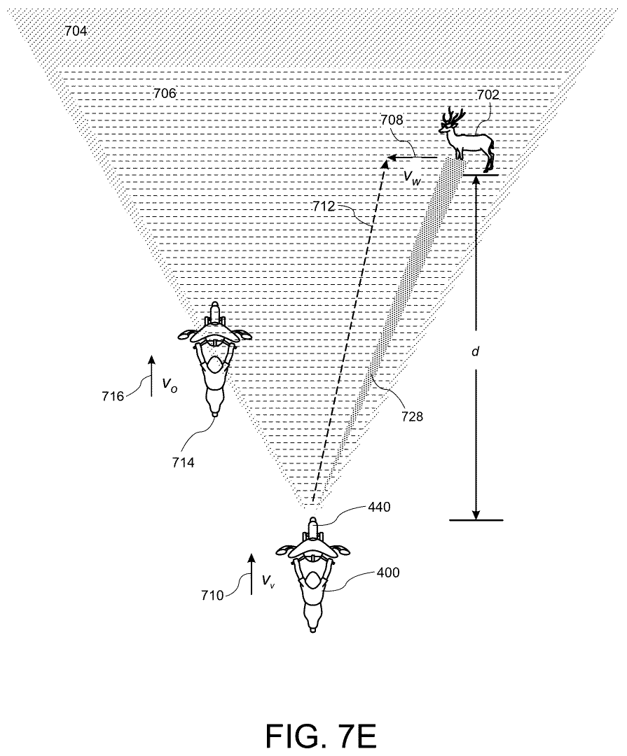

In one or more embodiments, the environment scanning may include radar imaging and thermal imaging. This will be described in greater detail with reference to FIG. 7A.

FIG. 7A illustrates a top-down view of vehicle 400 in a first non-limiting example hypothetical situation for detecting an object using radar imaging and thermal imaging in accordance with one or more embodiments.

As shown in the figure, wildlife 702 and a riding buddy 704 are near vehicle 400. A radar system (not shown) of vehicle 400 has a field of view 706 and a thermal imaging system (not shown) of vehicle 400 has a field of view 708. For purposes of discussion only, in this example, let the radar system and the thermal imaging system both be part of sensor system 408. Further, for purposes of discussion, let wildlife 702 and riding buddy 704 be within field of view 706 and field of view 708.

As further shown in the figure, wildlife 702 is separated from vehicle 400 by a distance dw and has a velocity vw indicated by arrow 710. Riding buddy 704 is separated from vehicle 400 by a distance db and has a velocity vb indicated by arrow 712. Vehicle 400 is traveling at a velocity vᵥ as indicated by arrow 714 and has a bearing toward wildlife 702 as indicated by arrow 716.

In this first non-limiting example hypothetical situation, the radar system may provide a radar image signal corresponding to field of view 706, which includes the radar image of wildlife 702, whereas the thermal imaging system may provide a thermal image signal of field of view 708, which includes a thermal image of wildlife 702.

It should be noted that the first non-limiting example hypothetical situation discussed above with respect to FIG. 7A is provided for purposes of discussion. In particular, in accordance with one or more embodiments, a vehicle may scan 360^{o} for an object. Furthermore, in accordance with one or more embodiments, a vehicle may scan with additional sensors, non-limiting examples of which include: one or more IR still cameras; one or more visible spectrum still cameras; one or more UV still cameras; one or more hyperspectral still cameras configured to generate a still image include at least two of the IR spectrum, the visible spectrum, and the UV spectrum; one or more IR video cameras; one or more visible spectrum video cameras; one or more UV video cameras; one or more hyperspectral video cameras configured to generate a video image include at least two of the IR spectrum, the visible spectrum, and the UV spectrum; one or more microphones; one or more radars; one or more LIDAR sensors; one or more temperature sensors; one or more rain sensors; one or more light sensors; one or more pressure sensors; and combinations thereof.

FIG. 7B illustrates a top-down view of vehicle 400 in a second non-limiting example hypothetical situation for detecting an object using radar imaging and thermal imaging in accordance with one or more embodiments.

As shown in the figure, a dog 718 and a person 720 are near vehicle 400. For purposes of discussion, let dog 718 be separated from person 720 by a distance d, and let dog 718 and person 720 be within field of view 706 and field of view 708. Still further, for purposes of discussion, let the distance d be 4 feet, as person 720 is walking dog 718 on a leash.

In this second non-limiting example hypothetical situation, the radar system may provide a radar image signal corresponding to field of view 706, which includes the radar image of dog 718 and person 720, whereas the thermal imaging system may provide a thermal image signal of field of view 708, which includes a thermal image of dog 718 and person 720.

FIG. 7C illustrates a top-down view of vehicle 400 in a third non-limiting example hypothetical situation for detecting an object using radar imaging and thermal imaging in accordance with one or more embodiments.

As shown in the figure, a bicyclist 722 is near vehicle 400. For purposes of discussion, let bicyclist 722 be within field of view 706 and field of view 708.

As further shown in the figure, bicyclist 722 is separated from vehicle 400 by a distance db and has a velocity v_{b} indicated by arrow 724.

In this third non-limiting example hypothetical situation, the radar system may provide a radar image signal corresponding to field of view 706, which includes the radar image of bicyclist 722, whereas the thermal imaging system may provide a thermal image signal of field of view 708, which includes a thermal image of bicyclist 722.

FIG. 7D illustrates a top-down view of vehicle 400 in a fourth non-limiting example hypothetical situation for detecting an object using radar imaging and thermal imaging in accordance with one or more embodiments.

As shown in the figure, an immobile object 726 is near vehicle 400. For purposes of discussion, let immobile object 726 be within field of view 706 and field of view 708.

As further shown in the figure, immobile object 726 is separated from vehicle 400 by a distance do.

In this fourth non-limiting example hypothetical situation, the radar system may provide a radar image signal corresponding to field of view 706, which includes the radar image of immobile object 726, whereas the thermal imaging system may provide a thermal image signal of field of view 708, which includes a thermal image of immobile object 726.

Returning to FIG. 4, both the thermal image signal and the radar image signal may be provided to mitigation system 402 by sensor system 408.

Returning to FIG. 6, after the environment is scanned (S604), the environmental data is analyzed (S606). For example, returning to FIG. 5, system controller 502 may execute instructions in mitigation program 506 to analyze the environmental data.

For purposes of discussion only, continuing with the first non-limiting example hypothetical situation discussed above with reference to FIG. 7A, system controller 502 may execute instructions in mitigation program 506 to analyze the radar image signal and the thermal image signal.

In one or more embodiments, mitigation program 506 includes instructions, that when executed by system controller 502, cause system controller 502 to identify wildlife 702 and riding buddy 704 from at least one of the radar image signal, the thermal image signal, and combinations thereof. In one or more of these embodiments, mitigation program 506 includes instructions, that when executed by system controller 502, cause system controller 502 to identify wildlife 702 and riding buddy via feature extraction, object localization, classification, and bounding box prediction. During feature extraction, in one or more embodiments, a convolution neural network extracts relevant features from an image associated with the at least one of the radar image signal and the thermal image signal. During object localization, potential regions of interest where objects might be located are identified. During classification, the objects within these regions are classified. During bounding box prediction, for each detected object, bounding box coordinates are generated to indicate its location and size.

For purposes of discussion only, continuing with the second non-limiting example hypothetical situation discussed above with reference to FIG. 7B, system controller 502 may execute instructions in mitigation program 506 to analyze the radar image signal and the thermal image signal.

In one or more embodiments, mitigation program 506 includes instructions, that when executed by system controller 502, cause system controller 502 to identify dog 718 and person 720 from at least one of the radar image signal, the thermal image signal, and combinations thereof. In one or more of these embodiments, mitigation program 506 includes instructions, that when executed by system controller 502, cause system controller 502 to identify dog 718 and person 720 via feature extraction, object localization, classification, and bounding box prediction. During feature extraction, in one or more embodiments, a convolution neural network extracts relevant features from an image associated with the at least one of the radar image signal and the thermal image signal. During object localization, potential regions of interest where objects might be located are identified. During classification, the objects within these regions are classified. During bounding box prediction, for each detected object, bounding box coordinates are generated to indicate its location and size.

For purposes of discussion only, continuing with the third non-limiting example hypothetical situation discussed above with reference to FIG. 7C, system controller 502 may execute instructions in mitigation program 506 to analyze the radar image signal and the thermal image signal.

In one or more embodiments, mitigation program 506 includes instructions, that when executed by system controller 502, cause system controller 502 to identify bicyclist 722 from at least one of the radar image signal, the thermal image signal, and combinations thereof. In one or more of these embodiments, mitigation program 506 includes instructions, that when executed by system controller 502, cause system controller 502 to identify bicyclist via feature extraction, object localization, classification, and bounding box prediction. During feature extraction, in one or more embodiments, a convolution neural network extracts relevant features from an image associated with the at least one of the radar image signal and the thermal image signal. During object localization, potential regions of interest where objects might be located are identified. During classification, the objects within these regions are classified. During bounding box prediction, for each detected object, bounding box coordinates are generated to indicate its location and size.

For purposes of discussion only, continuing with the fourth non-limiting example hypothetical situation discussed above with reference to FIG. 7D, system controller 502 may execute instructions in mitigation program 506 to analyze the radar image signal and the thermal image signal.

In one or more embodiments, mitigation program 506 includes instructions, that when executed by system controller 502, cause system controller 502 to identify immobile object 726 from at least one of the radar image signal, the thermal image signal, and combinations thereof. In one or more of these embodiments, mitigation program 506 includes instructions, that when executed by system controller 502, cause system controller 502 to identify immobile object via feature extraction, object localization, classification, and bounding box prediction. During feature extraction, in one or more embodiments, a convolution neural network extracts relevant features from an image associated with the at least one of the radar image signal and the thermal image signal. During object localization, potential regions of interest where objects might be located are identified. During classification, the objects within these regions are classified. During bounding box prediction, for each detected object, bounding box coordinates are generated to indicate its location and size.

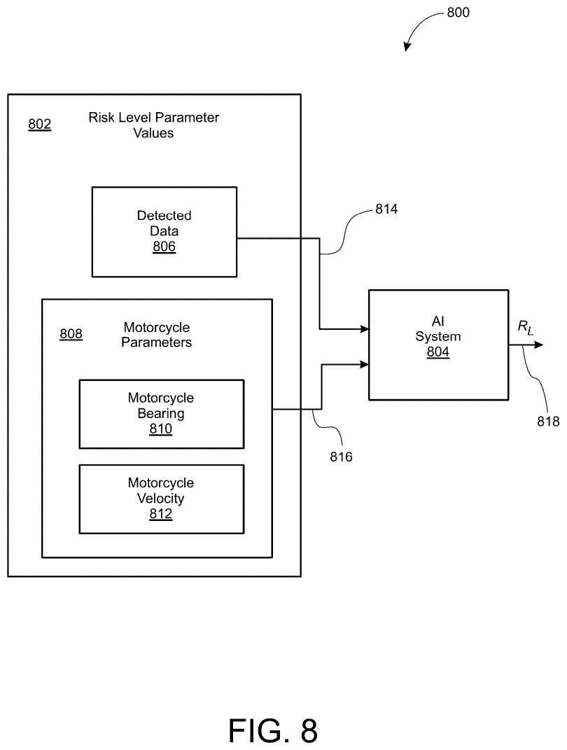

Returning to FIG. 5, in operation of one or more embodiments, system controller 502 may execute instructions in mitigation program 506 to cause system controller 502 to analyze data as provided by sensor system 408 via a machine learning process. This will be described in greater detail with reference to FIGS. 8-13.

FIG. 8 illustrates a block diagram of an example process 800 for which system controller 502 will execute instructions in mitigation program 506 to determine a risk level of a detected object in accordance with one or more embodiments.

As shown in the figure, a plurality of risk level parameter values 802 within mitigation program 506 for which controller 502 will execute in additional instructions in mitigation program 506, as represented in the figure as an artificial intelligence (“AI”) system 804, to output a risk level R_{L} 818 In one or more embodiments, the parameters within risk level parameter values 802 include detected data parameter values 806 associated with sensor data and motorcycle parameter values 808 associated with motorcycle data. In one or more embodiments, motorcycle parameter values 808 include motorcycle bearing parameter values 810 associated with motorcycle bearing data and motorcycle velocity parameter values 812 associated with motorcycle velocity data.

In one or more embodiments, detected data parameter values 806 correspond to data parameter values of signals provided by sensor system 408 for which vehicle 400 may use to scan the environment around vehicle 400, non-limiting examples of which include: one or more IR still cameras; one or more visible spectrum still cameras; one or more UV still cameras; one or more hyperspectral still cameras configured to generate a still image include at least two of the IR spectrum, the visible spectrum, and the UV spectrum; one or more IR video cameras; one or more visible spectrum video cameras; one or more UV video cameras; one or more hyperspectral video cameras configured to generate a video image include at least two of the IR spectrum, the visible spectrum, and the UV spectrum; one or more microphones; one or more radars; one or more LIDAR sensors; one or more temperature sensors; one or more rain sensors; one or more light sensors; one or more pressure sensors; and combinations thereof

Motorcycle parameter values 808 correspond to real time motorcycle parameter values as provided by at least one of drivetrain system 416, powertrain system 418, and ADAS 420. In one or more embodiments, motorcycle bearing parameter values 810 correspond to a current bearing value of vehicle 400.

In one or more embodiments, motorcycle velocity parameter values 812 correspond to a current velocity value of vehicle 400.

In one or more embodiments, output detected data parameter values 814 from detected data parameter values 806 and output motorcycle parameter values 816 from motorcycle parameter values 808 are provided to AI system 804.

In one or more embodiments, AI system 804 may take the form of any device or system that is configured as algorithms that can analyze and interpret parameter values from risk level parameter values 802 to identify patterns, make predictions, and inform decision-making processes to output a risk level R_{L}. In one or more embodiments, AI system 804 may take the form of a machine learning algorithm. In one or more embodiments, AI system 804 includes at least one of a supervised learning neural network, a reinforcement learning neural network, and combinations thereof. In one or more of these embodiments, AI system 804 is a pre-trained neural network to output a risk level R_{L} based on known risk level parameter values associated with objects within an area around a vehicle. In one or more of these embodiments, AI system 804 is a federated neural network that has been pre-trained on known risk level parameter values associated with objects within an area around a plurality of vehicles.

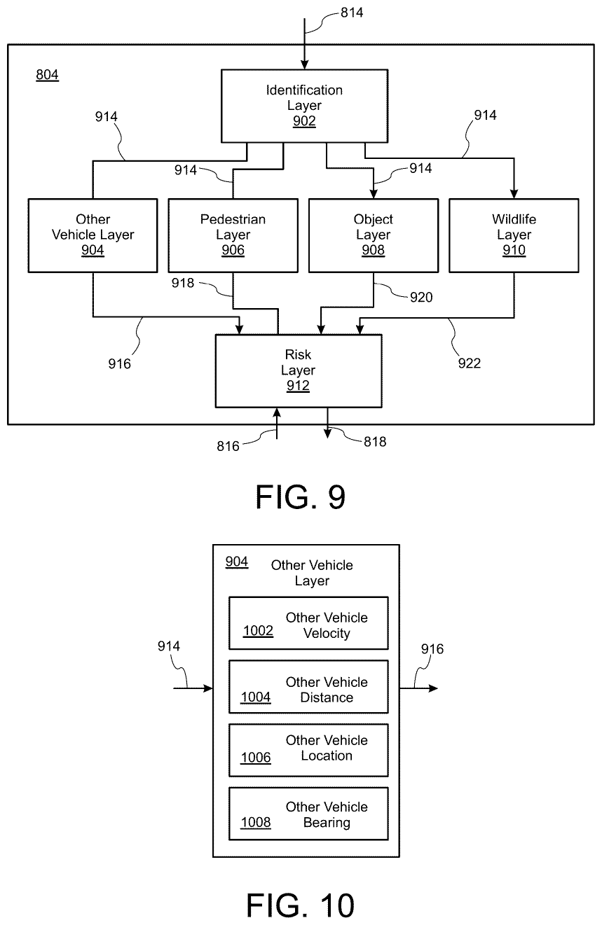

FIG. 9 illustrates a block diagram of AI system 804 in accordance with one or more embodiments.

As shown in the figure, AI system 804 includes an identification layer 902, an other vehicle layer 904, a pedestrian layer 906, an object layer 908, a wildlife layer 910, and a risk layer 912.

In one or more embodiments, AI system 804 may be pre-trained to determine an object level on training data from at least one of historical data, synthetic data, a priori data, and combinations thereof.

Historical data is data that is based on information collected from past events, situations, or phenomena that have been previously recorded or recorded over a previous time period.

In one or more embodiments, training historical data that is used to train AI system 804 may include: historical IR still image data associated with a pedestrian standing at different locations and distances from an IR still camera; historical IR still image data associated with a pedestrian running or jogging at different locations, different distances, and different velocities relative to an IR still camera; historical IR still image data associated with different types and sizes of animals standing at different locations and distances from an IR still camera; historical IR still image data associated with different types and sizes of animals running at different locations, different distances, and different velocities relative to an IR still camera; historical IR still image data associated with different types of immobile vehicles at different locations and distances from an IR still camera; historical IR still image data associated with different types of vehicles moving at different locations, different distances, and different velocities relative to an IR still camera; historical IR still image data associated with immobile object, such as tires, trash, etc., located at different locations and distances from an IR still camera; and combinations thereof.

In one or more embodiments, training historical data that is used to train AI system 804 may include: historical visible spectrum still image data associated with a pedestrian standing at different locations and distances from a visible spectrum still camera; historical visible spectrum still image data associated with a pedestrian running or jogging at different locations, different distances, and different velocities relative to a visible spectrum still camera; historical visible spectrum still image data associated with different types and sizes of animals standing at different locations and distances from a visible spectrum still camera; historical visible spectrum still image data associated with different types and sizes of animals running at different locations, different distances, and different velocities relative to a visible spectrum still camera; historical visible spectrum still image data associated with different types of immobile vehicles at different locations and distances from a visible spectrum still camera; historical visible spectrum still image data associated with different types of vehicles moving at different locations, different distances, and different velocities relative to a visible spectrum still camera; historical visible spectrum still image data associated with immobile object, such as tires, trash, etc., located at different locations and distances from a visible spectrum still camera; and combinations thereof.

In one or more embodiments, training historical data that is used to train AI system 804 may include: historical UV still image data associated with a pedestrian standing at different locations and distances from an UV still camera; historical UV still image data associated with a pedestrian running or jogging at different locations, different distances, and different velocities relative to an UV still camera; historical UV still image data associated with different types and sizes of animals standing at different locations and distances from an UV still camera; historical UV still image data associated with different types and sizes of animals running at different locations, different distances, and different velocities relative to an UV still camera; historical UV still image data associated with different types of immobile vehicles at different locations and distances from an UV still camera; historical UV still image data associated with different types of vehicles moving at different locations, different distances, and different velocities relative to an UV still camera; historical UV still image data associated with immobile object, such as tires, trash, etc., located at different locations and distances from an UV still camera; and combinations thereof.

In one or more embodiments, training historical data that is used to train AI system 804 may include: historical hyperspectral still image data associated with a pedestrian standing at different locations and distances from an hyperspectral still camera; historical hyperspectral still image data associated with a pedestrian running or jogging at different locations, different distances, and different velocities relative to an hyperspectral still camera; historical hyperspectral still image data associated with different types and sizes of animals standing at different locations and distances from an hyperspectral still camera; historical hyperspectral still image data associated with different types and sizes of animals running at different locations, different distances, and different velocities relative to an hyperspectral still camera; historical hyperspectral still image data associated with different types of immobile vehicles at different locations and distances from an hyperspectral still camera; historical hyperspectral still image data associated with different types of vehicles moving at different locations, different distances, and different velocities relative to an hyperspectral still camera; historical hyperspectral still image data associated with immobile object, such as tires, trash, etc., located at different locations and distances from an hyperspectral still camera; and combinations thereof.

In one or more embodiments, training historical data that is used to train AI system 804 may include: historical IR video image data associated with a pedestrian standing at different locations and distances from an IR video camera; historical IR video image data associated with a pedestrian running or jogging at different locations, different distances, and different velocities relative to an IR video camera; historical IR video image data associated with different types and sizes of animals standing at different locations and distances from an IR video camera; historical IR video image data associated with different types and sizes of animals running at different locations, different distances, and different velocities relative to an IR video camera; historical IR video image data associated with different types of immobile vehicles at different locations and distances from an IR video camera; historical IR video image data associated with different types of vehicles moving at different locations, different distances, and different velocities relative to an IR video camera; historical IR video image data associated with immobile object, such as tires, trash, etc., located at different locations and distances from an IR video camera; and combinations thereof.

In one or more embodiments, training historical data that is used to train AI system 804 may include: historical visible spectrum video image data associated with a pedestrian standing at different locations and distances from a visible spectrum video camera; historical visible spectrum video image data associated with a pedestrian running or jogging at different locations, different distances, and different velocities relative to a visible spectrum video camera; historical visible spectrum video image data associated with different types and sizes of animals standing at different locations and distances from a visible spectrum video camera; historical visible spectrum video image data associated with different types and sizes of animals running at different locations, different distances, and different velocities relative to a visible spectrum video camera; historical visible spectrum video image data associated with different types of immobile vehicles at different locations and distances from a visible spectrum video camera; historical visible spectrum video image data associated with different types of vehicles moving at different locations, different distances, and different velocities relative to a visible spectrum video camera; historical visible spectrum video image data associated with immobile object, such as tires, trash, etc., located at different locations and distances from a visible spectrum video camera; and combinations thereof.

In one or more embodiments, training historical data that is used to train AI system 804 may include: historical UV video image data associated with a pedestrian standing at different locations and distances from an UV video camera; historical UV video image data associated with a pedestrian running or jogging at different locations, different distances, and different velocities relative to an UV video camera; historical UV video image data associated with different types and sizes of animals standing at different locations and distances from an UV video camera; historical UV video image data associated with different types and sizes of animals running at different locations, different distances, and different velocities relative to an UV video camera; historical UV video image data associated with different types of immobile vehicles at different locations and distances from an UV video camera; historical UV video image data associated with different types of vehicles moving at different locations, different distances, and different velocities relative to an UV video camera; historical UV video image data associated with immobile object, such as tires, trash, etc., located at different locations and distances from an UV video camera; and combinations thereof.

In one or more embodiments, training historical data that is used to train AI system 804 may include: historical hyperspectral video image data associated with a pedestrian standing at different locations and distances from an hyperspectral video camera; historical hyperspectral video image data associated with a pedestrian running or jogging at different locations, different distances, and different velocities relative to an hyperspectral video camera; historical hyperspectral video image data associated with different types and sizes of animals standing at different locations and distances from an hyperspectral video camera; historical hyperspectral video image data associated with different types and sizes of animals running at different locations, different distances, and different velocities relative to an hyperspectral video camera; historical hyperspectral video image data associated with different types of immobile vehicles at different locations and distances from an hyperspectral video camera; historical hyperspectral video image data associated with different types of vehicles moving at different locations, different distances, and different velocities relative to an hyperspectral video camera; historical hyperspectral video image data associated with immobile object, such as tires, trash, etc., located at different locations and distances from an hyperspectral video camera; and combinations thereof.

In one or more embodiments, training historical data that is used to train AI system 804 may include: historical audio data associated with a pedestrian talking, yelling, singing, etc., while standing at different locations and distances from a microphone; historical audio data associated with a pedestrian talking, yelling, singing, etc., while running or jogging at different locations, different distances, and different velocities relative to a microphone; historical audio data associated with different types and sizes of animals making noises while standing at different locations and distances from a microphone; historical audio data associated with different types and sizes of animals making noises while running at different locations, different distances, and different velocities relative to a microphone; historical audio data associated with different types of immobile vehicles making noises at different locations and distances from a microphone; and historical audio data associated with different types of vehicles making noise while moving at different locations, different distances, and different velocities relative to a microphone.

In one or more embodiments, training historical data that is used to train AI system 804 may include: historical LIDAR image data associated with a pedestrian standing at different locations and distances from a LIDAR sensor; historical LIDAR image data associated with a pedestrian running or jogging at different locations, different distances, and different velocities relative to a LIDAR sensor; historical LIDAR image data associated with different types and sizes of animals standing at different locations and distances from a LIDAR sensor; historical LIDAR image data associated with different types and sizes of animals running at different locations, different distances, and different velocities relative to a LIDAR sensor; historical LIDAR image data associated with different types of immobile vehicles at different locations and distances from a LIDAR sensor; historical LIDAR image data associated with different types of vehicles moving at different locations, different distances, and different velocities relative to a LIDAR sensor; and historical LIDAR image data associated with immobile object, such as tires, trash, etc., located at different locations and distances from a LIDAR sensor; and combinations thereof.

In one or more embodiments, training historical data that is used to train AI system 804 may include: historical temperature data associated with a pedestrian standing at different locations and distances from a temperature sensor; historical temperature data associated with a pedestrian running or jogging at different locations, different distances, and different velocities relative to a temperature sensor; historical temperature data associated with different types and sizes of animals standing at different locations and distances from a temperature sensor; historical temperature data associated with different types and sizes of animals running at different locations, different distances, and different velocities relative to a temperature sensor; historical temperature data associated with different types of immobile vehicles at different locations and distances from a temperature sensor; historical temperature data associated with different types of vehicles moving at different locations, different distances, and different velocities relative to a temperature sensor; and historical temperature data associated with immobile object, such as tires, trash, etc., located at different locations and distances from a temperature sensor; and combinations thereof.

In one or more embodiments, training historical data that is used to train AI system 804 may include historical rain data as detected from a rain sensor.

In one or more embodiments, training historical data that is used to train AI system 804 may include historical light data as detected by a light sensor.

In one or more embodiments, training historical data that is used to train AI system 804 may include historical pressure data as detected by a pressure sensor.

Synthetic data is artificially generated data based on historical data that mimics the patterns and characteristics of historical data.

In one or more embodiments, training synthetic data that is used to train AI system 804 may include: synthetic data that is based on historical IR still image data associated with a pedestrian standing at different locations and distances from an IR still camera; synthetic data that is based on historical IR still image data associated with a pedestrian running or jogging at different locations, different distances, and different velocities relative to an IR still camera; synthetic data that is based on historical IR still image data associated with different types and sizes of animals standing at different locations and distances from an IR still camera; synthetic data that is based on historical IR still image data associated with different types and sizes of animals running at different locations, different distances, and different velocities relative to an IR still camera; synthetic data that is based on historical IR still image data associated with different types of immobile vehicles at different locations and distances from an IR still camera; synthetic data that is based on historical IR still image data associated with different types of vehicles moving at different locations, different distances, and different velocities relative to an IR still camera; synthetic data that is based on historical IR still image data associated with immobile object, such as tires, trash, etc., located at different locations and distances from an IR still camera; and combinations thereof.

In one or more embodiments, training synthetic data that is used to train AI system 804 may include: synthetic data that is based on historical visible spectrum still image data associated with a pedestrian standing at different locations and distances from a visible spectrum still camera; synthetic data that is based on historical visible spectrum still image data associated with a pedestrian running or jogging at different locations, different distances, and different velocities relative to a visible spectrum still camera; synthetic data that is based on historical visible spectrum still image data associated with different types and sizes of animals standing at different locations and distances from a visible spectrum still camera; synthetic data that is based on historical visible spectrum still image data associated with different types and sizes of animals running at different locations, different distances, and different velocities relative to a visible spectrum still camera; synthetic data that is based on historical visible spectrum still image data associated with different types of immobile vehicles at different locations and distances from a visible spectrum still camera; synthetic data that is based on historical visible spectrum still image data associated with different types of vehicles moving at different locations, different distances, and different velocities relative to a visible spectrum still camera; synthetic data that is based on historical visible spectrum still image data associated with immobile object, such as tires, trash, etc., located at different locations and distances from a visible spectrum still camera; and combinations thereof.

In one or more embodiments, training synthetic data that is used to train AI system 804 may include: synthetic data that is based on historical UV still image data associated with a pedestrian standing at different locations and distances from an UV still camera; synthetic data that is based on historical UV still image data associated with a pedestrian running or jogging at different locations, different distances, and different velocities relative to an UV still camera; synthetic data that is based on historical UV still image data associated with different types and sizes of animals standing at different locations and distances from an UV still camera; synthetic data that is based on historical UV still image data associated with different types and sizes of animals running at different locations, different distances, and different velocities relative to an UV still camera; synthetic data that is based on historical UV still image data associated with different types of immobile vehicles at different locations and distances from an UV still camera; synthetic data that is based on historical UV still image data associated with different types of vehicles moving at different locations, different distances, and different velocities relative to an UV still camera; synthetic data that is based on historical UV still image data associated with immobile object, such as tires, trash, etc., located at different locations and distances from an UV still camera; and combinations thereof.

In one or more embodiments, training synthetic data that is used to train AI system 804 may include: synthetic data that is based on historical hyperspectral still image data associated with a pedestrian standing at different locations and distances from an hyperspectral still camera; synthetic data that is based on historical hyperspectral still image data associated with a pedestrian running or jogging at different locations, different distances, and different velocities relative to an hyperspectral still camera; synthetic data that is based on historical hyperspectral still image data associated with different types and sizes of animals standing at different locations and distances from an hyperspectral still camera; synthetic data that is based on historical hyperspectral still image data associated with different types and sizes of animals running at different locations, different distances, and different velocities relative to an hyperspectral still camera; synthetic data that is based on historical hyperspectral still image data associated with different types of immobile vehicles at different locations and distances from an hyperspectral still camera; synthetic data that is based on historical hyperspectral still image data associated with different types of vehicles moving at different locations, different distances, and different velocities relative to an hyperspectral still camera; synthetic data that is based on historical hyperspectral still image data associated with immobile object, such as tires, trash, etc., located at different locations and distances from an hyperspectral still camera; and combinations thereof.

In one or more embodiments, training synthetic data that is used to train AI system 804 may include: synthetic data that is based on historical IR video image data associated with a pedestrian standing at different locations and distances from an IR video camera; synthetic data that is based on historical IR video image data associated with a pedestrian running or jogging at different locations, different distances, and different velocities relative to an IR video camera; synthetic data that is based on historical IR video image data associated with different types and sizes of animals standing at different locations and distances from an IR video camera; synthetic data that is based on historical IR video image data associated with different types and sizes of animals running at different locations, different distances, and different velocities relative to an IR video camera; synthetic data that is based on historical IR video image data associated with different types of immobile vehicles at different locations and distances from an IR video camera; synthetic data that is based on historical IR video image data associated with different types of vehicles moving at different locations, different distances, and different velocities relative to an IR video camera; synthetic data that is based on historical IR video image data associated with immobile object, such as tires, trash, etc., located at different locations and distances from an IR video camera; and combinations thereof.

In one or more embodiments, training synthetic data that is used to train AI system 804 may include: synthetic data that is based on historical visible spectrum video image data associated with a pedestrian standing at different locations and distances from a visible spectrum video camera; synthetic data that is based on historical visible spectrum video image data associated with a pedestrian running or jogging at different locations, different distances, and different velocities relative to a visible spectrum video camera; synthetic data that is based on historical visible spectrum video image data associated with different types and sizes of animals standing at different locations and distances from a visible spectrum video camera; synthetic data that is based on historical visible spectrum video image data associated with different types and sizes of animals running at different locations, different distances, and different velocities relative to a visible spectrum video camera; synthetic data that is based on historical visible spectrum video image data associated with different types of immobile vehicles at different locations and distances from a visible spectrum video camera; synthetic data that is based on historical visible spectrum video image data associated with different types of vehicles moving at different locations, different distances, and different velocities relative to a visible spectrum video camera; synthetic data that is based on historical visible spectrum video image data associated with immobile object, such as tires, trash, etc., located at different locations and distances from a visible spectrum video camera; and combinations thereof.

In one or more embodiments, training synthetic data that is used to train AI system 804 may include: synthetic data that is based on historical UV video image data associated with a pedestrian standing at different locations and distances from an UV video camera; synthetic data that is based on historical UV video image data associated with a pedestrian running or jogging at different locations, different distances, and different velocities relative to an UV video camera; synthetic data that is based on historical UV video image data associated with different types and sizes of animals standing at different locations and distances from an UV video camera; synthetic data that is based on historical UV video image data associated with different types and sizes of animals running at different locations, different distances, and different velocities relative to an UV video camera; synthetic data that is based on historical UV video image data associated with different types of immobile vehicles at different locations and distances from an UV video camera; synthetic data that is based on historical UV video image data associated with different types of vehicles moving at different locations, different distances, and different velocities relative to an UV video camera; synthetic data that is based on historical UV video image data associated with immobile object, such as tires, trash, etc., located at different locations and distances from an UV video camera; and combinations thereof.

In one or more embodiments, training synthetic data that is used to train AI system 804 may include: synthetic data that is based on historical hyperspectral video image data associated with a pedestrian standing at different locations and distances from an hyperspectral video camera; synthetic data that is based on historical hyperspectral video image data associated with a pedestrian running or jogging at different locations, different distances, and different velocities relative to an hyperspectral video camera; synthetic data that is based on historical hyperspectral video image data associated with different types and sizes of animals standing at different locations and distances from an hyperspectral video camera; synthetic data that is based on historical hyperspectral video image data associated with different types and sizes of animals running at different locations, different distances, and different velocities relative to an hyperspectral video camera; synthetic data that is based on historical hyperspectral video image data associated with different types of immobile vehicles at different locations and distances from an hyperspectral video camera; synthetic data that is based on historical hyperspectral video image data associated with different types of vehicles moving at different locations, different distances, and different velocities relative to an hyperspectral video camera; synthetic data that is based on historical hyperspectral video image data associated with immobile object, such as tires, trash, etc., located at different locations and distances from an hyperspectral video camera; and combinations thereof.

In one or more embodiments, training synthetic data that is used to train AI system 804 may include: synthetic data that is based on historical audio data associated with a pedestrian talking, yelling, singing, etc., while standing at different locations and distances from a microphone; synthetic data that is based on historical audio data associated with a pedestrian talking, yelling, singing, etc., while running or jogging at different locations, different distances, and different velocities relative to a microphone; synthetic data that is based on historical audio data associated with different types and sizes of animals making noises while standing at different locations and distances from a microphone; synthetic data that is based on historical audio data associated with different types and sizes of animals making noises while running at different locations, different distances, and different velocities relative to a microphone; synthetic data that is based on historical audio data associated with different types of immobile vehicles making noises at different locations and distances from a microphone; and synthetic data that is based on historical audio data associated with different types of vehicles making noise while moving at different locations, different distances, and different velocities relative to a microphone.

In one or more embodiments, training synthetic data that is used to train AI system 804 may include: synthetic data that is based on historical LIDAR image data associated with a pedestrian standing at different locations and distances from a LIDAR sensor; synthetic data that is based on historical LIDAR image data associated with a pedestrian running or jogging at different locations, different distances, and different velocities relative to a LIDAR sensor; synthetic data that is based on historical LIDAR image data associated with different types and sizes of animals standing at different locations and distances from a LIDAR sensor; synthetic data that is based on historical LIDAR image data associated with different types and sizes of animals running at different locations, different distances, and different velocities relative to a LIDAR sensor; synthetic data that is based on historical LIDAR image data associated with different types of immobile vehicles at different locations and distances from a LIDAR sensor; synthetic data that is based on historical LIDAR image data associated with different types of vehicles moving at different locations, different distances, and different velocities relative to a LIDAR sensor; and synthetic data that is based on historical LIDAR image data associated with immobile object, such as tires, trash, etc., located at different locations and distances from a LIDAR sensor; and combinations thereof.

In one or more embodiments, training synthetic data that is used to train AI system 804 may include: synthetic data that is based on historical temperature data associated with a pedestrian standing at different locations and distances from a temperature sensor; synthetic data that is based on historical temperature data associated with a pedestrian running or jogging at different locations, different distances, and different velocities relative to a temperature sensor; synthetic data that is based on historical temperature data associated with different types and sizes of animals standing at different locations and distances from a temperature sensor; synthetic data that is based on historical temperature data associated with different types and sizes of animals running at different locations, different distances, and different velocities relative to a temperature sensor; synthetic data that is based on historical temperature data associated with different types of immobile vehicles at different locations and distances from a temperature sensor; synthetic data that is based on historical temperature data associated with different types of vehicles moving at different locations, different distances, and different velocities relative to a temperature sensor; and synthetic data that is based on historical temperature data associated with immobile object, such as tires, trash, etc., located at different locations and distances from a temperature sensor; and combinations thereof.

In one or more embodiments, training synthetic data that is used to train AI system 804 may include synthetic data that is based on historical rain data as detected from a rain sensor.

In one or more embodiments, training synthetic data that is used to train AI system 804 may include synthetic data that is based on historical light data as detected by a light sensor.

In one or more embodiments, training synthetic data that is used to train AI system 804 may include synthetic data that is based on historical pressure data as detected by a pressure sensor.

A priori data refers to knowledge or assumptions made based on deductive reasoning or existing information, without relying on empirical evidence or new observations. A priori data is derived from logical reasoning and known facts rather than from experience or experimentation.

In one or more embodiments, training a priori data that is used to train AI system 804 may include: a priori IR still image data associated with a pedestrian standing at different locations and distances from an IR still camera; a priori IR still image data associated with a pedestrian running or jogging at different locations, different distances, and different velocities relative to an IR still camera; a priori IR still image data associated with different types and sizes of animals standing at different locations and distances from an IR still camera; a priori IR still image data associated with different types and sizes of animals running at different locations, different distances, and different velocities relative to an IR still camera; a priori IR still image data associated with different types of immobile vehicles at different locations and distances from an IR still camera; a priori IR still image data associated with different types of vehicles moving at different locations, different distances, and different velocities relative to an IR still camera; a priori IR still image data associated with immobile object, such as tires, trash, etc., located at different locations and distances from an IR still camera; and combinations thereof.

In one or more embodiments, training a priori data that is used to train AI system 804 may include: a priori visible spectrum still image data associated with a pedestrian standing at different locations and distances from a visible spectrum still camera; a priori visible spectrum still image data associated with a pedestrian running or jogging at different locations, different distances, and different velocities relative to a visible spectrum still camera; a priori visible spectrum still image data associated with different types and sizes of animals standing at different locations and distances from a visible spectrum still camera; a priori visible spectrum still image data associated with different types and sizes of animals running at different locations, different distances, and different velocities relative to a visible spectrum still camera; a priori visible spectrum still image data associated with different types of immobile vehicles at different locations and distances from a visible spectrum still camera; a priori visible spectrum still image data associated with different types of vehicles moving at different locations, different distances, and different velocities relative to a visible spectrum still camera; a priori visible spectrum still image data associated with immobile object, such as tires, trash, etc., located at different locations and distances from a visible spectrum still camera; and combinations thereof.

In one or more embodiments, training a priori data that is used to train AI system 804 may include: a priori UV still image data associated with a pedestrian standing at different locations and distances from an UV still camera; a priori UV still image data associated with a pedestrian running or jogging at different locations, different distances, and different velocities relative to an UV still camera; a priori UV still image data associated with different types and sizes of animals standing at different locations and distances from an UV still camera; a priori UV still image data associated with different types and sizes of animals running at different locations, different distances, and different velocities relative to an UV still camera; a priori UV still image data associated with different types of immobile vehicles at different locations and distances from an UV still camera; a priori UV still image data associated with different types of vehicles moving at different locations, different distances, and different velocities relative to an UV still camera; a priori UV still image data associated with immobile object, such as tires, trash, etc., located at different locations and distances from an UV still camera; and combinations thereof.

In one or more embodiments, training a priori data that is used to train AI system 804 may include: a priori hyperspectral still image data associated with a pedestrian standing at different locations and distances from an hyperspectral still camera; a priori hyperspectral still image data associated with a pedestrian running or jogging at different locations, different distances, and different velocities relative to an hyperspectral still camera; a priori hyperspectral still image data associated with different types and sizes of animals standing at different locations and distances from an hyperspectral still camera; a priori hyperspectral still image data associated with different types and sizes of animals running at different locations, different distances, and different velocities relative to an hyperspectral still camera; a priori hyperspectral still image data associated with different types of immobile vehicles at different locations and distances from an hyperspectral still camera; a priori hyperspectral still image data associated with different types of vehicles moving at different locations, different distances, and different velocities relative to an hyperspectral still camera; a priori hyperspectral still image data associated with immobile object, such as tires, trash, etc., located at different locations and distances from an hyperspectral still camera; and combinations thereof.

In one or more embodiments, training a priori data that is used to train AI system 804 may include: a priori IR video image data associated with a pedestrian standing at different locations and distances from an IR video camera; a priori IR video image data associated with a pedestrian running or jogging at different locations, different distances, and different velocities relative to an IR video camera; a priori IR video image data associated with different types and sizes of animals standing at different locations and distances from an IR video camera; a priori IR video image data associated with different types and sizes of animals running at different locations, different distances, and different velocities relative to an IR video camera; a priori IR video image data associated with different types of immobile vehicles at different locations and distances from an IR video camera; a priori IR video image data associated with different types of vehicles moving at different locations, different distances, and different velocities relative to an IR video camera; a priori IR video image data associated with immobile object, such as tires, trash, etc., located at different locations and distances from an IR video camera; and combinations thereof.

In one or more embodiments, training a priori data that is used to train AI system 804 may include: a priori visible spectrum video image data associated with a pedestrian standing at different locations and distances from a visible spectrum video camera; a priori visible spectrum video image data associated with a pedestrian running or jogging at different locations, different distances, and different velocities relative to a visible spectrum video camera; a priori visible spectrum video image data associated with different types and sizes of animals standing at different locations and distances from a visible spectrum video camera; a priori visible spectrum video image data associated with different types and sizes of animals running at different locations, different distances, and different velocities relative to a visible spectrum video camera; a priori visible spectrum video image data associated with different types of immobile vehicles at different locations and distances from a visible spectrum video camera; a priori visible spectrum video image data associated with different types of vehicles moving at different locations, different distances, and different velocities relative to a visible spectrum video camera; a priori visible spectrum video image data associated with immobile object, such as tires, trash, etc., located at different locations and distances from a visible spectrum video camera; and combinations thereof.

In one or more embodiments, training a priori data that is used to train AI system 804 may include: a priori UV video image data associated with a pedestrian standing at different locations and distances from an UV video camera; a priori UV video image data associated with a pedestrian running or jogging at different locations, different distances, and different velocities relative to an UV video camera; a priori UV video image data associated with different types and sizes of animals standing at different locations and distances from an UV video camera; a priori UV video image data associated with different types and sizes of animals running at different locations, different distances, and different velocities relative to an UV video camera; a priori UV video image data associated with different types of immobile vehicles at different locations and distances from an UV video camera; a priori UV video image data associated with different types of vehicles moving at different locations, different distances, and different velocities relative to an UV video camera; a priori UV video image data associated with immobile object, such as tires, trash, etc., located at different locations and distances from an UV video camera; and combinations thereof.

In one or more embodiments, training a priori data that is used to train AI system 804 may include: a priori hyperspectral video image data associated with a pedestrian standing at different locations and distances from an hyperspectral video camera; a priori hyperspectral video image data associated with a pedestrian running or jogging at different locations, different distances, and different velocities relative to an hyperspectral video camera; a priori hyperspectral video image data associated with different types and sizes of animals standing at different locations and distances from an hyperspectral video camera; a priori hyperspectral video image data associated with different types and sizes of animals running at different locations, different distances, and different velocities relative to an hyperspectral video camera; a priori hyperspectral video image data associated with different types of immobile vehicles at different locations and distances from an hyperspectral video camera; a priori hyperspectral video image data associated with different types of vehicles moving at different locations, different distances, and different velocities relative to an hyperspectral video camera; a priori hyperspectral video image data associated with immobile object, such as tires, trash, etc., located at different locations and distances from an hyperspectral video camera; and combinations thereof.

In one or more embodiments, training a priori data that is used to train AI system 804 may include: a priori audio data associated with a pedestrian talking, yelling, singing, etc., while standing at different locations and distances from a microphone; a priori audio data associated with a pedestrian talking, yelling, singing, etc., while running or jogging at different locations, different distances, and different velocities relative to a microphone; a priori audio data associated with different types and sizes of animals making noises while standing at different locations and distances from a microphone; a priori audio data associated with different types and sizes of animals making noises while running at different locations, different distances, and different velocities relative to a microphone; a priori audio data associated with different types of immobile vehicles making noises at different locations and distances from a microphone; and a priori audio data associated with different types of vehicles making noise while moving at different locations, different distances, and different velocities relative to a microphone.

In one or more embodiments, training a priori data that is used to train AI system 804 may include: a priori LIDAR image data associated with a pedestrian standing at different locations and distances from a LIDAR sensor; a priori LIDAR image data associated with a pedestrian running or jogging at different locations, different distances, and different velocities relative to a LIDAR sensor; a priori LIDAR image data associated with different types and sizes of animals standing at different locations and distances from a LIDAR sensor; a priori LIDAR image data associated with different types and sizes of animals running at different locations, different distances, and different velocities relative to a LIDAR sensor; a priori LIDAR image data associated with different types of immobile vehicles at different locations and distances from a LIDAR sensor; a priori LIDAR image data associated with different types of vehicles moving at different locations, different distances, and different velocities relative to a LIDAR sensor; and a priori LIDAR image data associated with immobile object, such as tires, trash, etc., located at different locations and distances from a LIDAR sensor; and combinations thereof.

In one or more embodiments, training a priori data that is used to train AI system 804 may include: a priori temperature data associated with a pedestrian standing at different locations and distances from a temperature sensor; a priori temperature data associated with a pedestrian running or jogging at different locations, different distances, and different velocities relative to a temperature sensor; a priori temperature data associated with different types and sizes of animals standing at different locations and distances from a temperature sensor; a priori temperature data associated with different types and sizes of animals running at different locations, different distances, and different velocities relative to a temperature sensor; a priori temperature data associated with different types of immobile vehicles at different locations and distances from a temperature sensor; a priori temperature data associated with different types of vehicles moving at different locations, different distances, and different velocities relative to a temperature sensor; and a priori temperature data associated with immobile object, such as tires, trash, etc., located at different locations and distances from a temperature sensor; and combinations thereof.

In one or more embodiments, training a priori data that is used to train AI system 804 may include a priori rain data as detected from a rain sensor.

In one or more embodiments, training a priori data that is used to train AI system 804 may include a priori light data as detected by a light sensor.

In one or more embodiments, training a priori data that is used to train AI system 804 may include a priori pressure data as detected by a pressure sensor.

In one or more embodiments, using training data as discussed above, identification layer 902 may be configured to receive detected data parameter values 814 and output: object identification embeddings 914 to other vehicle layer 904; object identification embeddings 914 to pedestrian layer 906; object identification embeddings 914 to object layer 908; and object identification embeddings 914 to wildlife layer 910.

Embeddings are low-dimensional, learned continuous vector representations of discrete variables. These vectors capture meaningful data about objects such as words, images, or videos, allowing AI system 804 to process them efficiently.

In one or more embodiments, once trained, identification layer 902 may output object identification embeddings 914 to identify a vehicle, may output object identification embeddings 914 to identify a pedestrian, may output object identification embeddings 914 to identify an immobile object, and may output object identification embeddings 914 to identify wildlife.

In one or more embodiments, in situations wherein a vehicle is near vehicle 400, once trained, other vehicle layer 904 may be configured to output other vehicle embeddings 916 based on object identification embeddings 914. This will be described in greater detail with reference to FIG. 10.

FIG. 10 illustrates a block diagram of other vehicle layer 904 in accordance with one or more embodiments.

As shown in the figure, other vehicle layer 904 includes an other vehicle velocity layer 1002, an other vehicle distance layer 1004, an other vehicle location layer 1006, and an other vehicle bearing layer 1008.

In one or more embodiments, other vehicle velocity layer 1002 corresponds to a current velocity of a vehicle that is near vehicle 400 in situations wherein a vehicle is near vehicle 400.

In one or more embodiments, other vehicle distance layer 1004 corresponds to a current distance of from vehicle 400 of a vehicle that is near vehicle 400 in situations wherein a vehicle is near vehicle 400.

In one or more embodiments, other vehicle location layer 1006 corresponds to a current location relative to vehicle 400 of a vehicle that is near vehicle 400 in situations wherein a vehicle is near vehicle 400.

In one or more embodiments, other vehicle bearing layer 1008 corresponds to a current bearing of a vehicle that is near vehicle 400 in situations wherein a vehicle is near vehicle 400.

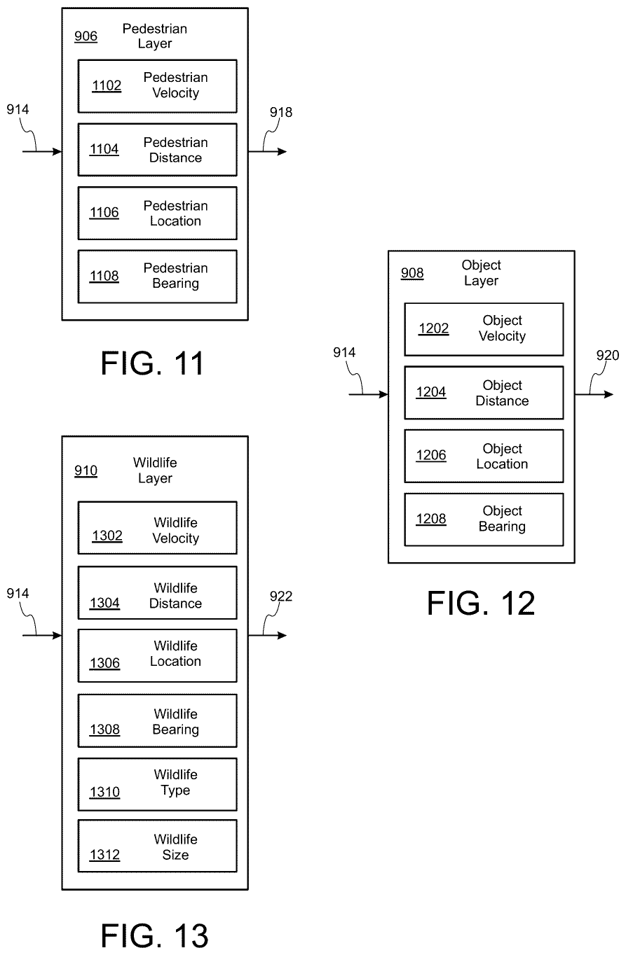

Returning to FIG. 9, in one or more embodiments, in situations wherein a pedestrian is near vehicle 400, once trained, pedestrian layer 906 may be configured to output pedestrian embeddings 918 based on object identification embeddings 914. This will be described in greater detail with reference to FIG. 11.

FIG. 11 illustrates a block diagram of pedestrian layer 906 in accordance with one or more embodiments.

As shown in the figure, pedestrian layer 906 includes a pedestrian velocity layer 1102, a pedestrian distance layer 1104, a pedestrian location layer 1106, and a pedestrian bearing layer 1108.

In one or more embodiments, pedestrian velocity layer 1102 corresponds to a velocity of a pedestrian that is near vehicle 400, in situations wherein a pedestrian is near vehicle 400.

In one or more embodiments, pedestrian distance layer 1104 corresponds to the distance from vehicle 400 of a pedestrian, in situations wherein a pedestrian is near vehicle 400.

In one or more embodiments, pedestrian location layer 1106 corresponds to a location, relative to vehicle 400, of a pedestrian, in situations wherein a pedestrian is near vehicle 400.

In one or more embodiments, pedestrian bearing layer 1108 corresponds to a bearing of a pedestrian, in situations wherein a pedestrian is near vehicle 400.

Returning to FIG. 9, in one or more embodiments, in situations wherein an immobile object is near vehicle 400, once trained, object layer 908 may be configured to output object embeddings 920 based on object identification embeddings 914. This will be described in greater detail with reference to FIG. 12.

FIG. 12 illustrates a block diagram of object layer 908 in accordance with one or more embodiments.

As shown in the figure, object layer 908 includes an object velocity layer 1202, an object distance layer 1204, an object location layer 1206, and an object bearing layer 1208.

In one or more embodiments, object velocity layer 1202 corresponds to a velocity of an object, which will be zero as the object is immobile, that is near vehicle 400, in situations wherein an immobile object is near vehicle 400.

In one or more embodiments, object distance layer 1204 corresponds to a distance relative to vehicle 400 of an object, in situations wherein an object is near vehicle 400.

In one or more embodiments, object location layer 1206 corresponds to a location relative to vehicle 400 of an object, in situations wherein an immobile object is near vehicle 400.

In one or more embodiments, object bearing layer 1208 corresponds to a bearing of an immobile object, which in this case will be no bearing, in situations wherein an immobile object is near vehicle 400.

Returning to FIG. 9, in one or more embodiments, in situations wherein a wildlife is near vehicle 400, once trained, wildlife layer 910 may be configured to output wildlife embeddings 922 based on object identification embeddings 914. This will be described in greater detail with reference to FIG. 13.

Returning to FIG. 9, in one or more embodiments, wildlife layer 910 may be configured to output wildlife embeddings 922 based on object identification embeddings 914.

FIG. 13 illustrates a block diagram of wildlife layer 910 in accordance with one or more embodiments.

As shown in the figure, wildlife layer 910 includes a wildlife velocity layer 1302, a wildlife distance layer 1304, a wildlife location layer 1306, a wildlife bearing layer 1308, a wildlife type layer 1310, and a wildlife size layer 1312.

In one or more embodiments, wildlife velocity layer 1302 corresponds to the velocity of wildlife near vehicle 400, in situations wherein wildlife is near vehicle 400.

In one or more embodiments, wildlife distance layer 1304 corresponds to the distance from vehicle 400 of wildlife, in situations wherein wildlife is near vehicle 400.

In one or more embodiments, wildlife location layer 1306 corresponds to the location relative to vehicle 400 of wildlife, in situations wherein wildlife is near vehicle 400.

In one or more embodiments, wildlife bearing layer 1308 corresponds to the bearing of wildlife near vehicle 400, in situations wherein wildlife is near vehicle 400.

In one or more embodiments, wildlife type layer 1310 corresponds to the type of wildlife near vehicle 400, in situations wherein wildlife is near vehicle 400.

In one or more embodiments, wildlife size layer 1312 corresponds to the size of wildlife near vehicle 400, in situations wherein wildlife is near vehicle 400.

Returning to FIG. 4, in operation of one or more embodiments, drivetrain system 416 may provide drivetrain system data to mitigation system 402, powertrain system 418 may provide powertrain system data to mitigation system 402, ADAS 420 may provide ADAS data to mitigation system 402 and sensor system 408 may provide sensor data to mitigation system 402. As shown in FIG. 5, system controller 502 of mitigation system 402 may execute instructions in mitigation program 506 to cause system controller 502 to analyze the sensor data and motorcycle data to determine an object level. As shown in FIG. 8, system controller 502 of mitigation system 402 may execute instructions in mitigation program 506 to cause system controller 502 to provide detected data parameter values 814 to AI system 804 and to provide motorcycle parameter values 816 to AI system 804. As shown in FIG. 9, risk layer 912 will analyze: other vehicle embeddings 916 from other vehicle layer 904; pedestrian embeddings 918 from pedestrian layer 906; object embeddings 920 from object layer 908; wildlife embeddings 922 from wildlife layer 910; and motorcycle parameter values 816 from to generate a risk level R_{L} 818.

For example, consider the first non-limiting example hypothetical situation discussed above with reference to FIG. 7A. In operation of one or more embodiments, drivetrain system 416 may provide drivetrain system data to mitigation system 402, powertrain system 418 may provide powertrain system data to mitigation system 402, ADAS 420 may provide ADAS data to mitigation system 402 indicating that vehicle 400 is traveling at velocity vᵥ. Sensor system 408 may radar and thermal imaging data to mitigation system 402 indicating: an image of wildlife 702, a location of wildlife 702 relative to vehicle 400, a distance d_{w} to wildlife 702, the velocity v_{w} of wildlife 702, the bearing of wildlife 702, an image of riding buddy 704, a location of riding buddy 704 relative to vehicle 400, a distance d_{b} to riding buddy 704, the velocity v_{b} of riding buddy 704, and the bearing of riding buddy 704.

As shown in FIG. 9, risk layer 912 will more heavily weigh the analysis of other vehicle embeddings 916 from other vehicle layer 904, wildlife embeddings 922 from wildlife layer 910, and motorcycle parameter values 816 as the trained AI system 804 will recognize wildlife and another vehicle. Further, risk layer 912 will less weigh the analysis of pedestrian embeddings 918 from pedestrian layer 906 or object embeddings 920 from object layer 908 as the trained AI system 804 will not recognize a pedestrian or immobile object.

Ultimately, risk layer 912 will generate a risk level R_{L} 818 of wildlife 702 and riding buddy 704 based on the input from sensor output as shown in FIG. 7A.

Now consider the second non-limiting example hypothetical situation discussed above with reference to FIG. 7B. In operation of one or more embodiments, drivetrain system 416 may provide drivetrain system data to mitigation system 402, powertrain system 418 may provide powertrain system data to mitigation system 402, ADAS 420 may provide ADAS data to mitigation system 402 indicating that vehicle 400 is traveling at velocity vᵥ. Sensor system 408 may radar and thermal imaging data to mitigation system 402 indicating: an image of dog 718, an image of person 720, a location of dog 718 relative to vehicle 400, a location of person 720 relative to vehicle 400, a distance to dog 718, a distance to person 720, a distance between dog 718 and person 720, the velocity of dog 718, the velocity of person 720, the bearing of dog 718, and the bearing of person 720.

As shown in FIG. 9, risk layer 912 will more heavily weigh the analysis of pedestrian embeddings 918 from pedestrian layer 906, wildlife embeddings 922 from wildlife layer 910, and motorcycle parameter values 816 as the trained AI system 804 will recognize the pedestrian and wildlife. Further, risk layer 912 will less weigh the analysis of other vehicle embeddings 916 from other vehicle layer 904 or object embeddings 920 from object layer 908 as the trained AI system 804 will not recognize another vehicle or immobile object. In one or more embodiments, risk layer 912 will be trained to determine when an animal is within a predetermined distance to a pedestrian, then neither the animal nor pedestrian is an object, e.g., when a person is walking their dog.

Ultimately, risk layer 912 will generate a risk level R_{L} 818 of dog 718 and person 720 based on the input from sensor output as shown in FIG. 7A.

Now consider the third non-limiting example hypothetical situation discussed above with reference to FIG. 7C. In operation of one or more embodiments, drivetrain system 416 may provide drivetrain system data to mitigation system 402, powertrain system 418 may provide powertrain system data to mitigation system 402, ADAS 420 may provide ADAS data to mitigation system 402 indicating that vehicle 400 is traveling at velocity vᵥ. Sensor system 408 may radar and thermal imaging data to mitigation system 402 indicating: an image of bicyclist 722, a location of bicyclist 722 relative to vehicle 400, a distance d_{b} to bicyclist 722, the velocity v_{b} of bicyclist, and the bearing of bicyclist 722.

As shown in FIG. 9, risk layer 912 will more heavily weigh the analysis of other vehicle embeddings 916 from other vehicle layer 904, pedestrian embeddings 918 from pedestrian layer 906, and motorcycle parameter values 816 as the trained AI system 804 will recognize the pedestrian and the bicycle. Further, risk layer 912 will less weigh the analysis of object embeddings 920 from object layer 908 or wildlife embeddings 922 from wildlife layer 910 as the trained AI system 804 will not recognize an immobile object or wildlife.

Ultimately, risk layer 912 will generate a risk level R_{L} 818 of bicyclist 722 based on the input from sensor output as shown in FIG. 7A.

Now consider the fourth non-limiting example hypothetical situation discussed above with reference to FIG. 7D. In operation of one or more embodiments, drivetrain system 416 may provide drivetrain system data to mitigation system 402, powertrain system 418 may provide powertrain system data to mitigation system 402, ADAS 420 may provide ADAS data to mitigation system 402 indicating that vehicle 400 is traveling at velocity vᵥ. Sensor system 408 may provide radar and thermal imaging data to mitigation system 402 indicating: an image of immobile object 726, a location of immobile object 726 relative to vehicle 400, a distance dₒ to immobile object, the velocity of zero (0) of immobile object 726, and the bearing of zero (0) of immobile object 726.

As shown in FIG. 9, risk layer 912 will more heavily weigh the analysis of object embeddings 920 from object layer 908, and motorcycle parameter values 816 as the trained AI system 804 will recognize the immobile object. Further, risk layer 912 will provide a lower weight value to the analysis of other vehicle embeddings 916 from other vehicle layer 904, pedestrian embeddings 918 from pedestrian layer 906, or wildlife embeddings 922 from wildlife layer 910 as the trained AI system 804 will not recognize another vehicle, a pedestrian, or wildlife.

Ultimately, risk layer 912 will generate a risk level R_{L} 818 of immobile object 726 based on the input from sensor output as shown in FIG. 7A.

Returning to FIG. 6, after the risk level R_{L} is determined (S606), it is determined whether the risk level R_{L} is less than a predetermined risk level threshold R_{threshold} (S608). For example, returning to FIG. 5, mitigation program 506 may have predetermined risk level threshold R_{threshold} stored therein. Further, mitigation program 506 may have instructions, that when executed by system controller 502, cause system controller 502 to compare the determined risk level R_{L} with predetermined risk level threshold R_{threshold} and determine whether the risk level R_{L} is less than the predetermined risk level threshold R_{threshold}.

Returning to FIG. 6, if it is determined that the risk level R_{L} is less than the predetermined risk level threshold R_{threshold} (Y at S608), then the environment is again scanned (return to S604).

If it is determined that the risk level R_{L} is not less than the predetermined risk level threshold R_{threshold} (N at S608), then a warning is activated (S610). For example, returning to FIG. 5, mitigation program 506 may have instructions, that when executed by system controller 502, cause mitigation system 402 to activate a warning.

In one or more embodiments, for example referring to FIG. 4, mitigation system 402 may cause vehicle 400 to activate a warning selected from a group of warnings including an audible signal, a visual indicator, a haptic signal, a wireless signal, and combinations thereof.

There are unique challenges on a motorcycle when the rider's alertness is constantly active, wherein it may not be desired to require the rider to take their eyes of the road to discern the location of an object. In one or more embodiments, mitigation system 402 may cause vehicle 400 to activate a warning signal by providing stereo alerts, haptic alerts, vibrating mirror alerts, light projecting alerts, and braking alerts.

In one or more embodiments, mitigation system 402 may cause audio system 404 to provide an audible signal to warn the operator of vehicle 400. Returning to FIG. 2, in one or more of these embodiments, mitigation system 402 may cause audio system 404 to cause front right speaker 212 to emit an audio warning when the object is right of center of the direction of travel of motorcycle 100, and cause front left speaker 214 to emit an audio warning when the object is left of center of the direction of travel of motorcycle 100. Accordingly, in this manner the rider is not required to take their eyes of the road to discern the location of an object.

In one or more embodiments, mitigation system 402 may cause audio system 404 to provide a haptic signal to warn the operator of vehicle 400. Returning to FIG. 2, in one or more of these embodiments, each of right handle bar grip 204 and left handle bar grip 206 may include a piezoelectric device configured to vibrate when provided an electric signal. In one or more of these embodiments, mitigation system 402 may cause right handle bar grip 204 to vibrate when the object is right of center of the direction of travel of motorcycle 100, and cause left handle bar grip 206 to vibrate when the object is left of center of the direction of travel of motorcycle 100. Accordingly, in this manner the rider is not required to take their eyes of the road to discern the location of an object.

In one or more embodiments, mitigation system 402 may cause audio system 404 to provide a vibration signal to warn the operator of vehicle 400. Returning to FIG. 2, in one or more of these embodiments, each of right rear view mirror 208 and left rear view mirror 210 may include a piezoelectric device configured to vibrate when provided an electric signal. In one or more of these embodiments, mitigation system 402 may cause right rear view mirror 208 to vibrate when the object is right of center of the direction of travel of motorcycle 100, and cause left rear view mirror 210 to vibrate when the object is left of center of the direction of travel of motorcycle 100. Accordingly, in this manner the rider is not required to take their eyes of the road to discern the location of an object.

In one or more embodiments, mitigation system 402 may cause vehicle 400 to activate a warning signal by instructing infotainment system 406 to provide a visual signal to warn the operator of vehicle 400. In one or more embodiments, mitigation system 402 may cause lighting system 414 to provide modify lights of vehicle 400 to warn the operator of vehicle 400. In one or more of these embodiments, mitigation system 402 may cause vehicle 400 to cause steerable illuminator 440 to provide a directed light at the object. In one or more of these embodiments, the directed light is a color that is different from the headlight color of vehicle 400, e.g., red. In one or more other of these embodiments, mitigation system 402 may cause vehicle 400 to steerable illuminator 440 to provide a directed light at the ground toward the object. This will be described in greater detail with reference to FIG. 7E.

FIG. 7E illustrates a top-down view of vehicle 400 of FIG. 7A, wherein steerable illuminator 440 provides a directed light 728 at the ground in the direction of wildlife 702. Accordingly, in this manner the rider is not required to take their eyes of the road to discern the location of an object.

In one or more embodiments, mitigation system 402 may cause vehicle 400 to activate a warning signal by instructing wearable system 412 to provide a haptic signal to warn the operator of vehicle 400. Further, in one or more embodiments, mitigation system 402 may cause vehicle 400 to activate a warning signal by automatically honking a horn (not shown).

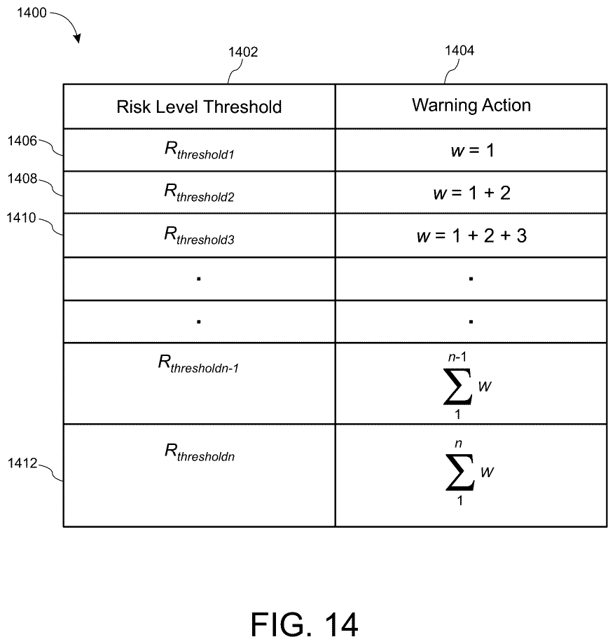

In one or more embodiments, mitigation system 402 may cause vehicle 400 to activate a warning signal based on of many different predetermined levels of risk. This will be described in greater detail with reference to FIG. 14.

FIG. 14 illustrates a table 1400 associating increasing risk level thresholds with corresponding warning actions in accordance with one or more embodiments.

As shown in the figure, table 1400 include a column 1402, a column 1404, and a plurality of rows, a sample of which are indicated as rows 1406, 1408, 1410, and 1412.

Column 1402 corresponds to a risk level threshold, whereas column 1404 corresponds to a warning action to be performed based on the corresponding risk level threshold.

Row 1406 illustrates that for a first threshold level R_{threshold1}, a first warning action would be performed, w=1. For example, for purposes of discussion only, let a first warning action to be performed for a lowest risk level, which would correspond to the first threshold level R_{threshold1}, be flashing of a headlight. Further, in this example, let an identification of a small rabbit on the side of the road be determined by AI system 804 to have a risk level R_{L} that is larger than R_{threshold1}. In this case, as shown in FIG. 4, mitigation system 402 may instruct lighting system 414 to flash a headlight. Such a headlight flashing would warn the driver of the vehicle of a low object level of wildlife in an area around the vehicle.

Returning to FIG. 14, row 1408 illustrates that for a second threshold level R_{threshold2}, the first warning action would be performed and a second warning action would be performed, w=1+2. For example, for purposes of discussion only, let a first warning action be the same as that discussed in the example above and let a second warning action to be performed for a next-higher risk level, which would correspond to the second threshold level R_{threshold2}, be providing an icon of the identified wildlife with a location vector on TFT screen 202. Further, in this example, let an identification of a medium-sized dog on the side of the road be determined by AI system 804 to have a risk level R_{L} that is larger than R_{threshold2}. In this case, as shown in FIG. 4, mitigation system 402 may instruct lighting system 414 to flash a headlight and instruct infotainment system 406 to display an icon of a dog with a location vector on its TFT screen. Such a headlight flashing would warn the driver of the vehicle of the wildlife in an area around the vehicle and the displaying of the dog icon would further warn the driver of the location of the dog.

Returning to FIG. 14, row 1410 illustrates that for a third threshold level R_{threshold3}, the first warning action, the second warning action and a third warning action would be performed, w=1+2+3. For example, for purposes of discussion only, let a first warning action and the second warning action be the same as that discussed in the example above and let a third warning action to be performed for a next-higher risk level, which would correspond to the third threshold level R_{threshold3}, be illuminating the wildlife. Further, in this example, let an identification of a deer on the side of the road be determined by AI system 804 to have a risk level R_{L} that is larger than R_{threshold3}. In this case, as shown in FIG. 4, mitigation system 402 may instruct lighting system 414 to flash a headlight, instruct infotainment system 406 to display an icon of a deer with a location vector on its TFT screen, and may instruct steerable illuminator 440 to steer to and illuminate the deer. Such a headlight flashing and icon display would warn the driver of the vehicle of the wildlife in an area around the vehicle and the illuminating of the deer would further warn the driver of the location of the dog.

In one or more embodiments, the threshold levels may be incremented as desired. For example, returning to FIG. 14, row 1412 illustrates that for nth threshold level R_{thresholdn}, the sum of the first through n^{th} warning actions would be performed, w=1+2+3. . . +n.

In one or more embodiments, returning to FIG. 4, infotainment system 406 may be configured to enable a rider to modify one or more risk level thresholds within column 1402.

Returning to FIG. 6, after a warning is activated (S610), method 600 stops (S612).

In one or more embodiments, a user may adjust a risk level of wildlife based on at least one of the risk level parameters associated with risk level parameter values 802.

In one or more embodiments, a user may adjust a risk level of wildlife based on the wildlife type. In one or more of these embodiments, the risk level parameter of wildlife type may have different preset risk level parameter values for moose, bears, deer, rabbits, and birds. In one or more of these embodiments, a user may change at least one of these preset risk level parameter values, via a user interface within infotainment system 406.

In one or more embodiments, a user may adjust a risk level of wildlife based on the wildlife size. For example, in one or more of these embodiments, the risk level parameter of wildlife size may have different preset risk level parameter values for different sizes of birds. In one or more of these embodiments, a user may change at least one of these preset risk level parameter values, via a user interface within infotainment system 406.

In one or more embodiments, a user may adjust a risk level of wildlife based on the wildlife distance. For example, in one or more of these embodiments, the risk level parameter of wildlife distance may have different preset risk level parameter values for different distances of the wildlife with reference to the vehicle. In one or more of these embodiments, a user may change at least one of these preset risk level parameter values, via a user interface within infotainment system 406.

In one or more embodiments, a user may adjust a risk level of wildlife based on the wildlife velocity. For example, in one or more of these embodiments, the risk level parameter of wildlife velocity may have different preset risk level parameter values for different velocities of the wildlife. In one or more embodiments, the velocity of the wildlife may be determined by comparing the location of the wildlife, as determined from environment scans as discussed above with reference to FIG. 7A, at different times. In one or more of these embodiments, a user may change at least one of these preset risk level parameter values, via a user interface within infotainment system 406.

In one or more embodiments, a combination of the wildlife size and wildlife velocity may be used as a separate risk level parameter value. In particular, a potential impact force would be greater with a larger and faster moving wildlife.

In one or more embodiments, a user may adjust a risk level of wildlife based on the vehicle bearing. For example, in one or more of these embodiments, the risk level parameter of vehicle bearing may have different preset risk level parameter values for different bearings of the vehicle relative to the wildlife. In one or more of these embodiments, a user may change at least one of these preset risk level parameter values, via a user interface within infotainment system 406.

In one or more embodiments, a user may adjust a risk level of wildlife based on the vehicle velocity. For example, in one or more of these embodiments, the risk level parameter of wildlife velocity may have different preset risk level parameter values for different velocities of the vehicle. In one or more of these embodiments, a user may change at least one of these preset risk level parameter values, via a user interface within infotainment system 406.

In one or more embodiments, a risk level may be determined based on predetermined estimates of an amount of impact kinetic energy that vehicle 400 may safely withstand.

In one or more embodiments, mitigation program 506 may have instructions, that when executed by system controller 502, cause vehicle to automatically activate a countermeasure, non-limiting examples of which include counter-steering, acceleration, deceleration, breaking, downshifting, and combinations thereof.

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to enable others skilled in the art to best utilize the disclosure in various embodiments and with various modifications as are suited to the particular use contemplated. It is intended that the scope of the disclosure be defined by the claims appended hereto.

What is claimed is:

1. A system for use with a vehicle, said system comprising:
a memory having instructions stored therein; and
a processor configured to execute the instructions to cause said system to:
determine whether wildlife is near the vehicle;
determine a risk level R_{L} of the wildlife;
determine whether R_{L} is less than a predetermined threshold risk level R_{threshold};
and
activate a warning to a driver of the vehicle when R_{L} is not less than R_{threshold}.

2. The system of claim 1, wherein said processor is configured to execute the instructions to cause said system to determine whether wildlife is near the vehicle by:
receiving data from at least one of a group of data types consisting of image data, thermal data, light detection and ranging (LIDAR) data, radar data, and combinations thereof; and
analyzing the received data.

3. The system of claim 2, wherein said processor is configured to execute the instructions to cause said system to determine whether wildlife is near the vehicle by analyzing the received data by comparing the received data with one of historical data associated with wildlife, synthetic data associated with wildlife, a priori data associated with wildlife, and combinations thereof.

4. The system of claim 3,
wherein said processor is configured to execute the instructions to cause said system to determine whether wildlife is near the vehicle by analyzing the received data with a pre-trained artificial intelligence system that has been pre-trained to identify wildlife based on training data from the at least one of the group of data types consisting of training image data, training thermal data, training LIDAR data, training radar data, and combinations thereof, and
wherein the received data corresponds to a field of view of at least one of the image data, the thermal data, the LIDAR data, the radar data, and combinations thereof.

5. The system of claim 1, wherein said processor is configured to execute the instructions to cause said system to determine the R_{L} of the wildlife based on a parameter selected from a group of parameters consisting of animal type, animal size, animal distance to the vehicle, animal velocity, bearing of the vehicle, vehicle velocity, and combinations thereof.

6. The system of claim 1, wherein said processor is configured to execute the instructions to cause said system to activate the warning as selected from a group of warnings consisting of an audible signal, a visual indicator, a haptic signal, a wireless signal, and combinations thereof.

7. The system of claim 6, wherein said processor is additionally configured to execute the instructions to cause said system to:
determine whether R_{L} is less than a predetermined second threshold risk level R_{threshold2};
activate a second warning to the driver of the vehicle when R_{L} is not less than R_{threshold2}; and
activate the second warning as selected from the group of warnings, wherein the warning is different from the second warning.

8. A system comprising:
a vehicle; and
a system comprising a memory and a processor, wherein said memory includes instructions stored therein, and wherein said processor is configured to execute the instructions to cause said system to:
determine whether wildlife is near said vehicle; determine a risk level R_{L} of the wildlife;
determine whether R_{L} is less than a predetermined threshold risk level R_{threshold};
and
activate a warning to a driver of said vehicle when R_{L} is not less than R_{threshold}.

9. The system of claim 8, wherein said processor is configured to execute the instructions to cause said system to determine whether wildlife is near said vehicle by:
receiving data from at least one of a group of data types consisting of image data, thermal data, LIDAR data, radar data, and combinations thereof; and
analyzing the received data.

10. The system of claim 9, wherein said processor is configured to execute the instructions to cause said system to determine whether wildlife is near said vehicle by analyzing the received data by comparing the received data with one of historical data associated with wildlife, synthetic data associated with wildlife, a priori data associated with wildlife, and combinations thereof.

11. The system of claim 10,
wherein said processor is configured to execute the instructions to cause said system to determine whether wildlife is near said vehicle by analyzing the received data with a pre-trained artificial intelligence system that has been pre-trained to identify wildlife based on training data from the at least one of the group of data types consisting of training image data, training thermal data, training LIDAR data, training radar data, and combinations thereof, and
wherein the received data corresponds to a field of view of at least one of the image data, the thermal data, the LIDAR data, the radar data, and combinations thereof.

12. The system of claim 8, wherein said processor is configured to execute the instructions to cause said system to determine the R_{L} of the wildlife based on parameter selected from a group of parameters consisting of animal type, animal size, animal distance to the vehicle, animal velocity, bearing of the vehicle, vehicle velocity, and combinations thereof.

13. The system of claim 8, wherein said processor is configured to execute the instructions to cause said system to activate the warning as selected from a group of warnings consisting of an audible signal, a visual indicator, a haptic signal, a wireless signal, and combinations thereof.

14. The system of claim 13, wherein said processor is additionally configured to execute the instructions to cause said system to:
determine whether R_{L} is less than a predetermined second threshold risk level R_{threshold2};
activate a second warning to the driver of said vehicle when R_{L} is not less than R_{threshold2}; and
activate the second warning as selected from the group of warnings, wherein the warning is different from the second warning.

15. A method of using a system, said method comprising:
determining, via a processor in the system comprising a memory and the processor, the memory including instructions stored therein, the processor being configured to execute the instructions, whether wildlife is near a vehicle having the system;
determining, via the processor, a risk level R_{L} of the wildlife;
determining, via the processor, whether R_{L} is less than a predetermined threshold risk level R_{threshold}; and
activating, via the processor, a warning to a driver of the vehicle when R_{L} is not less than R_{threshold}.

16. The method of claim 15, wherein said determining whether wildlife is near the vehicle having the system comprises:
receiving, via the processor, data of at least one of a group of data types consisting of image data, thermal data, LIDAR data, radar data, and combinations thereof; and
analyzing the received data.

17. The method of claim 16, wherein said analyzing the received data comprises analyzing, via the processor, the received data by comparing the received data with one of historical data associated with wildlife, synthetic data associated with wildlife, a priori data associated with wildlife, and combinations thereof.

18. The method of claim 17,
wherein said analyzing the received data comprises analyzing, via the processor, the received data by analyzing the received data with a pre-trained artificial intelligence system that has been pre-trained to identify wildlife based on training data from at least one of the group of data types consisting of training image data, training thermal data, training LIDAR data, training radar data, and combinations thereof.

19. The method of claim 15, wherein said determining the R_{L} of the wildlife is based on a parameter selected from a group of parameters consisting of animal type, animal size, animal distance to the vehicle, animal velocity, bearing of the vehicle, vehicle velocity, and combinations thereof.

20. The method of claim 15, wherein said activating the warning comprises activating the warning as selected from a group of warnings consisting of an audible signal, a visual indicator, a haptic signal, a wireless signal, and combinations thereof.
